(19) United States
(12) Patent Application Publication
(10) Pub. No.: US 2019/0276729 A1
(43) Pub. Date: Sep. 12, 2019

(54) Process

(71) Applicant: BP EXPLORATION OPERATING COMPANY LIMITED, Sunbury on Thames, Middlesex (GB)

(72) Inventors: Emma Jane CHAPMAN, Sunbury on Thames (GB); Rachel Kerry O'REILLY, Kenilworth (GB); Helen WILLCOCK, Kenilworth (GB); Rebecca Jane WILLIAMS, Kenilworth (GB)

(73) Assignee: BP Exploration Operating Company Limited, Sunbury on Thames, Middlesex (GB)

(21) Appl. No.: 16/319,327

(22) PCT Filed: Jul. 11, 2017
(86) PCT No.: PCT/EP2017/067441

§ 371 Date: Jan. 19, 2019

(30) Foreign Application Priority Data
Jul. 21, 2016 (GB) 1612678.1

(51) Int. Cl. C09K 8/575; C09K 8/588; C08F 20/34; C08F 12/28; C08F 26/06

(52) U.S. Cl. CPC C09K 8/5756; C09K 8/588; C08F 26/06; C08F 12/28; C08F 20/34

(57) ABSTRACT

A process for reducing the permeability to water of a thief zone of a porous and permeable subterranean petroleum reservoir includes injecting a composition comprising a dispersion of betainised crosslinked polymeric microparticles in an aqueous fluid down a well and into a thief zone. The betainised crosslinked polymeric microparticles have a transition temperature that is at or below the maximum temperature encountered in the thief zone and greater than the maximum temperature encountered in the well. The betainised crosslinked polymeric microparticles are solvated by water, expand in size and optionally aggregate in the thief zone when they encounter a temperature greater than the transition temperature so as to reduce the permeability of the thief zone to water.

### CROSS-REFERENCE TO RELATED APPLICATIONS

This application is a 35 U.S.C. § 371 national stage application of PCT/EP2017/067441 filed Jul. 11, 2017 and entitled “Process,” which claims priority to GB Application No. 1612678.1 filed Jul. 21, 2016 and entitled “Process,” both of which are hereby incorporated herein by reference in their entirety for all purposes.

### STATEMENT REGARDING FEDERALLY SPONSORED RESEARCH OR DEVELOPMENT

Not applicable.

### BACKGROUND

This invention relates to a method of modifying the permeability of a thief zone of a subterranean petroleum reservoir to water.

The invention also relates to a composition for use in a method of modifying the permeability to water of a thief zone of a subterranean petroleum reservoir, the composition comprising a dispersion of temperature-sensitive microparticles in water wherein the microparticles expand in size at above a threshold temperature.

Processes for modifying the permeability to water of subterranean petroleum reservoirs are particularly useful in the field of recovery of hydrocarbon fluids from a petroleum reservoir.

Crude oil may be recovered from a petroleum reservoir via natural pressure in the reservoir forcing hydrocarbon fluids towards production wells where they can flow or are pumped to a surface production facility (referred to as “primary recovery”). However, reservoir pressure is generally sufficient only to recover around 10 to 20 percent of the total hydrocarbon present in a subterranean petroleum reservoir. Accordingly “secondary recovery” techniques are applied to recover hydrocarbon from subterranean reservoirs in which the hydrocarbon fluids no longer flow by natural forces.

Secondary recovery relies on the supply of external energy to maintain the pressure in a subterranean petroleum reservoir and to sweep hydrocarbon fluids towards a production well. One such technique involves the injection of water (such as aquifer water, river water, estuarine water, seawater, or a produced water) into the petroleum reservoir via one or more injection wells to drive the hydrocarbon fluids towards one or more production wells. The injection of water during secondary recovery is commonly referred to as water flooding.

Enhanced Oil Recovery (EOR) processes involve injecting an aqueous fluid into a petroleum reservoir that is formulated to increase recovery of hydrocarbon fluids over that which would be achieved by water injection alone. The processes employed during enhanced oil recovery can be initiated at any time during the productive life of a petroleum reservoir. If an EOR process is employed in secondary recovery, the aqueous fluid supplies the external energy to maintain the pressure of the reservoir as well as increasing recovery of hydrocarbon fluids over that which would be achieved by water injection alone. If an EOR process is employed in tertiary recovery, injection of the original aqueous fluid is stopped and a different aqueous fluid is injected into the petroleum reservoir for enhanced oil recovery. The purpose of EOR is not only to restore reservoir pressure and to sweep oil towards a production well, but also to improve oil displacement or fluid flow in the reservoir.

The efficiency of water flooding techniques depends on a number of variables, including the permeability of the reservoir rock and the viscosity of the hydrocarbon fluids in the reservoir.

A prevalent problem with secondary and tertiary recovery projects relates to the heterogeneity of the reservoir rock strata. Natural variation in the permeability of different zones (layers or areas) of a subterranean petroleum reservoir means that the injected aqueous fluid tends to travel most easily in, and therefore preferentially sweeps, the highest permeability zones (i.e. the injected aqueous fluid follows the lowest resistance path from the injection well to the production well), thereby potentially by-passing much of the hydrocarbon fluid present in lower permeability zones of the reservoir. Once the highest permeability zones are thoroughly swept they tend to accept most of the injected aqueous fluid and act as “thief zones”. In such cases the injected aqueous fluid does not effectively sweep the hydrocarbon fluid from neighboring, lower permeability zones of the reservoir.

Herein, the term ‘thief zone’ refers to any region of high permeability relative to the permeabilities of the surrounding rock, such that a high proportion of the injected aqueous fluid flows through these regions. Such thief zones typically cannot be characterized by absolute values of permeability as the problem arises as a result of heterogeneity in the permeability of the reservoir rock; thus, a thief zone may simply be a region of higher permeability than the majority of the reservoir rock.

In order to improve sweep efficiency, these ‘thief zones’ can be partially or totally blocked deep in the reservoir, generating a new pressure gradient and diverting flow of subsequently injected fluid into lower permeability zones (layers or areas) of the reservoir with high hydrocarbon fluid (oil) saturation. Herein, sweep efficiency is taken to mean a measure of the effectiveness of a secondary or tertiary oil recovery process that depends on the proportion of the volume of the pore space of the reservoir contacted by the injected aqueous fluid.

Flow diversion involves changing the path of the injected aqueous fluid through the reservoir so that it contacts and displaces more hydrocarbon fluid (oil). Various physical and chemical treatment methods have been used to divert injected aqueous fluids from thief zones.

A few “deep reservoir flow diversion” processes have been developed with the aim of reducing the permeability in a substantial proportion of the thief zone at a significant distance from the injection and production wells. The use of swellable cross linked superabsorbent polymer microparticles for modifying the permeability of subterranean formations is disclosed in U.S. Pat. Nos. 5,465,792 and 5,735,349.

Deep reservoir flow diversion may also be achieved by injecting polymeric microparticles comprising polymeric chains linked together via thermally labile hydrolysable crosslinkers and non-thermally labile crosslinkers, as disclosed in U.S. Pat. Nos. 6,454,003, 6,729,402, 6,984,705 and 7,300,973. The suspension of microparticles travels through the thief zones and is progressively heated to a temperature at which the thermally labile crosslinkers hydrolyze and are broken and the microparticles absorb water, swell and block the pores of the reservoir rock. The permeability of the thief zone is thereby reduced and subsequently injected fluid is diverted into the lower permeability zones to displace hydrocarbon fluids towards a producing well. However, a feature of these expandable microparticles is that the block is permanent. In other words, the microparticles have no ability to shrink back to their original size and move to another location in the reservoir matrix rock and then re-expand to form a further block.

GB 2 262 117A describes certain latex microparticles that are temperature sensitive and reversibly flocculate, shrink and harden at higher temperatures, and disperse, expand and soften at lower temperatures and that these can form effective blocking agents in the presence of an ionic compound, in a petroleum reservoir. An advantage of the latex microparticles of GB 2 262 117A is that the block is reversible. This is because the microparticles deflocculate as the reservoir matrix cools in the vicinity of the original block such that the deflocculated microparticles become redispersed in the injection water and the resulting dispersion can propagate through the formation to set up a subsequent block deeper within the formation where the temperature is sufficiently high to promote reflocculation, shrinkage and hardening of the latex microparticles. However, a problem with the dispersions of GB 2 262 117A is that they are produced at the desired particle concentration for the fluid that is to be injected into the reservoir. Large amounts of the dispersion of GB 2 262 117 A would be required for the treatment of a reservoir. Accordingly, the cost of handling and shipping the required volume of dispersion renders the treatment uneconomic. Accordingly, the method of GB 2 262 117A has yet to be commercially deployed.

It has been reported (Schulz, D. N.; Peiffer, D. G.; Agarwal, P. K.; Larabee, J.; Kaladas, J. J.; Soni, L.; Handwerker, B.; Garner, R. T. Polymer 1986, 27, 1734 and Huglin, M. B.; Radwan, M. A. Polymer International 1991, 26, 97) that polysulfobetaines exhibit temperature responsive solubility in aqueous fluids and have an Upper Critical Solution Temperature (UCST) above which the polysulfobetaines transition from being insoluble to soluble in water.

A synthetic method for the preparation of particles having a low level of incorporation of sulfobetaine groups (up to 8%) is disclosed in “Zwitterionic Poly(betaine-N-isopropylacrylamide) Microgels: Properties and Applications”, Das, M.; Sanson, N.; Kumacheva, E. Chemistry of Materials 2008, 20, 7157). The behaviour of these particles is dominated by the properties of the non-betainised structural units (units derived from N isopropylacrylamide) such that the particles exhibit Lower Critical Solution Temperature (LCST) behaviour not UCST behaviour.

It has also been reported (Arjunan Vasantha, V.; Junhui, C.; Ying, T. B.; Parthiban, A. Langmuir 2015, 31, 11124 and Vasantha, V. A.; Jana, S.; Parthiban, A.; Vancso, J. G. RSC Advances 2014, 4, 22596) that linear polysulfabetaines exhibit temperature responsive behavior in aqueous fluids.

It is an object of the present invention to provide a method which overcomes or at least mitigates the disadvantages associated with conventional methods for reducing the permeability of a thief zone and in particular to increase or improve the recovery of hydrocarbon fluids from a reservoir.

According to the present invention there is provided a process for reducing the permeability to water of a thief zone of a porous and permeable subterranean petroleum reservoir, said process comprising injecting a dispersion of betainised crosslinked polymeric microparticles in an aqueous fluid down a well and into a thief zone, wherein the betainised crosslinked polymeric microparticles have a transition temperature which is at or below the maximum temperature encountered in the thief zone and greater than the maximum temperature encountered in the well, and wherein the betainised crosslinked polymeric microparticles are solvated by water and expand in size in the thief zone when they encounter a temperature at or greater than the transition temperature so as to reduce the permeability of the thief zone to water.

Thus, the betainised crosslinked polymeric microparticles are temperature responsive microparticles which exhibit a dramatic change in solvation and consequently a dramatic increase in particle size when dispersed in water at or above the transition temperature. Preferably, the extent of betainisation of the polymeric microparticles is selected such that the microparticles also aggregate at temperatures above the transition temperature. As discussed below, the extent to which the microparticles aggregate typically begins to decrease as the percentage betainisation of the betainisable functional groups exceeds 75%.

In another embodiment, the present invention provides a process for recovering hydrocarbon fluids from a porous and permeable subterranean petroleum reservoir comprising at least one higher permeability zone and at least one lower permeability zone that are penetrated by at least one injection well and at least one production well, the process comprising:
(i) injecting into the higher permeability (thief) zone of said reservoir a composition comprising betainised crosslinked polymeric microparticles dispersed in an aqueous fluid wherein the higher permeability zone has a region between the injection well and production well having a temperature at or above the transition temperature of the betainised crosslinked microparticles;
(ii) propagating said composition through the higher permeability zone until the composition reaches the region of the higher permeability zone having a temperature at or above the transition temperature such that the betainised crosslinked microparticles become solvated and expand in size thereby reducing the permeability of the higher permeability zone of the reservoir and diverting subsequently injected aqueous fluid into the lower permeability zone of the reservoir; and
(iii) recovering hydrocarbon fluids from said at least one production well.

Also, according to another aspect of the present invention, there is provided a composition comprising a dispersion of betainised crosslinked polymeric microparticles in an aqueous fluid wherein the microparticles have a transition temperature in the range of 20 to 120° C., for example, 45 to 120° C. at which the microparticles become solvated and expand in size.

The person skilled in the art will understand that the term “aqueous fluid” as used herein is intended to mean any aqueous solution suitable for use in a water flooding process in either secondary or tertiary recovery mode.

The person skilled in the art will understand that the transition temperature of the betainised crosslinked microparticles may be at or below the maximum temperature encountered in the thief zone of the reservoir provided that the maximum temperature encountered in the injection well, into which the dispersion is injected, is below the transition temperature. Suitably, the maximum temperature encountered in the injection well is 30° C. or less, preferably, 20° C. or less, in particular, 15° C. or less. Preferably, the composition is injected into the injection well at a temperature in the range of 4 to 30° C., more preferably, 4 to 20° C., in particular, 4 to 15° C.

Preferably, the transition temperature of the betainised crosslinked microparticles of the composition is at least 20° C., more preferably, at least 30° C., yet more preferably, at least 40° C., for example, at least 60° C. or at least 75° C. Preferably, the transition temperature of the betainised crosslinked polymeric microparticles is below 100° C., in particular, below 80° C.

In accordance with the process of the present invention, the composition comprising the betainised polymeric microparticles dispersed in an aqueous fluid is of relatively low viscosity and can be injected into the porous and permeable subterranean petroleum reservoir at relatively low injection pressures, with the proviso that the injection pressure is above the pressure within the pore space of the subterranean reservoir.

The initial (unexpanded) size of the betainised microparticles employed in the method of the present invention should be such that, prior to encountering a temperature within the thief zone that is at or greater than the transition temperature of the microparticles, efficient propagation of the composition through the pore structure of the reservoir rock, such as sandstone or carbonate, can be achieved. Thus, the betainised microparticles may propagate through low temperature regions of the thief zone of the reservoir substantially unimpeded. Typically, the initial average particle diameter of the microparticles is in the range of 0.05 to 1 μm, for example, 0.1 to 1 μm.

Once the composition reaches a region of the thief zone, having a temperature at or above the transition temperature, the microparticles expand in size and begin to aggregate. Typically, the aggregates comprising the expanded microparticles have an average particle diameter in the range of 0.3 to 20 μm, in particular, 1 to 20 μm, for example, 1 to 10 μm. Typically, the individual expanded microparticles of the aggregates have an average particle diameter in the range of 0.3 to 5 μm, in particular, 0.5 to 3 μm. Preferably, the ratio of the average particle diameter of the individual expanded microparticles to the initial average particle diameter of the microparticles is at least 2:1 preferably, at least 3:1. Preferably, the ratio of the volume of the individual expanded microparticles to the initial volume of the unexpanded microparticles is at least 5:1, preferably, at least 10:1, more preferably, at least 20:1.

Suitably, the region of the more permeable zone of the reservoir (thief zone), having a temperature above the transition temperature, is not so close to the injection well as to reduce injectivity of the dispersion and not so close to the production well that only a minor portion of the more permeable zone (thief zone) of the reservoir is swept by the subsequently injected aqueous fluid. Typically, aqueous injection fluids are at a lower temperature than the petroleum reservoir such that the injected fluid cools the reservoir giving rise to a temperature front in the reservoir which typically increases in radial distance from the injection well over time. The temperature front in the higher permeability zone (thief zone) is likely to be ahead of the temperature front in the lower permeability zone of the reservoir owing to the higher amounts of injected aqueous fluid that permeate through the thief zone. The region of the thief zone that is at a temperature at or above the transition temperature is preferably beyond the temperature front in the thief zone.

The process of the present invention is particularly suitable for the recovery of hydrocarbon fluids, in particular, crude oil, from subterranean petroleum reservoirs containing at least one high permeability zone between said at least one injection well and said at least one production well having a temperature, beyond the temperature front in the high permeability zone, of greater than 20° C., in particular, greater than 30° C., for example, greater than 50° C. For instance, the reservoir may contain at least one high permeability zone having a temperature, beyond the temperature front, in the range of 20 to 100° C., preferably, 30 to 100° C., for example, 40 to 90° C. or 60 to 90° C.

In the method of the present invention, most of the composition comprising the betainised crosslinked polymeric microparticles (hereinafter “betainised microparticles”) dispersed in an aqueous fluid will enter the thief zone of the reservoir since the composition will follow the most permeable and/or lowest pressure route or routes from the injection well to an associated production well. When the betainised microparticles expand in the region of the thief zone having a temperature above the transition temperature, they form a block to water. Thus, the permeability of water through the block of expanded microparticles is lower than the permeability of water through neighbouring zones of the reservoir such that subsequently injected aqueous fluid (water injected into the reservoir after the composition of the present invention) is largely diverted out of the thief zone and into neighbouring zones.

Depending on the degree of betainisation of the microparticles, the expanded microparticles may aggregate within the thief zone thereby aiding the formation of the block to water. Typically, expanded microparticles having a degree of betainisation of less than 95%, preferably, less than 85%, more preferably, less than 75% were found to aggregate at temperatures above the transition temperature. Without wishing to be bound by any theory, the microparticles start to expand at the transition temperature and aggregate at temperatures immediately above the transition temperature, for example, at a temperature that is 5° C. above the transition temperature.

Advantageously, aggregation of the betainised microparticles may be reversible such that cooling of the thief zone in the location of the block to a temperature below the transition temperature may result in disaggregation of the microparticles.

Advantageously, expansion of the betainised microparticles may also be reversible such that cooling of the thief zone in the location of the block to a temperature below the transition temperature results in desolvation of the microparticles and consequently contraction (shrinkage) of the microparticles.

The person skilled in the art will understand that cooling of the thief zone in the location of the block may occur due to a subsequently injected water flowing through neighbouring zones of the reservoir such that the temperature front in the neighbouring zones advances through the reservoir thereby cooling the thief zone in the location of the block. Accordingly, the contracted microparticles become redispersed in water and the resulting dispersion permeates through the thief zone until it reaches another location (region) where the temperature is at or above the transition temperature where the microparticles again expand and optionally aggregate. These steps of expansion, optional aggregation, optional disaggregation, contraction and redispersion may occur a plurality of times within the thief zone, thereby allowing a greater volume of the reservoir to be swept by the subsequently injected water.

In a further aspect of the present invention, there is provided a method for preparing betainised microparticles by reacting precursor polymeric microparticles (hereinafter “precursor microparticles”) comprising crosslinked polymer chains having pendant groups comprising a betainisable functional group with a betainisation reagent to convert at least a portion of the betainisable functional groups to betainised functional groups thereby forming betainised microparticles comprising crosslinked polymer chains having pendant groups comprising a betainised functional group and optionally pendant groups comprising an unreacted betainisable functional group.

The person skilled in the art will understand that the precursor polymeric microparticles may be reacted with betainising reagents selected from sulfobetainising, carboxybetainising, phosphobetainising, phosphonobetainising, and sulfabetainising reagents (including mixtures thereof) to form betainised microparticles in which at least a portion of the betainisable functional groups are converted to betainised functional groups. Preferably, the betainising reagents are selected from sulfobetainising and sulfabetainising reagents, in particular, sulfobetainisation reagents.

Preferably, the precursor microparticles comprise:

(a) structural units having (i) pendant groups comprising a betainisable functional group;

(b) structural units derived from crosslinking monomers containing at least two sites of ethylenic unsaturation; and

(c) optionally, structural units derived from hydrophobic comonomers that do not contain a betainisable functional group.

Accordingly, a mixture of monomers may be used in the synthesis of the precursor microparticles comprising:
(a) monomers having betainisable functional groups such as dialkylaminoalkylene, dialkylaminoaryl or N-heterocyclic amine functional groups;
(b) crosslinking monomers; and
(c) optionally, hydrophobic comonomers that do not contain a betainisable functional group.

Preferred monomers having betainisable functional groups that may be used to prepare the precursor microparticles include monomers selected from the group consisting of dialkylaminoalkyl acrylates; dialkylaminoalkyl alkacrylates; dialkylaminoalkyl acrylamides; dialkylaminoalkyl alkacrylamides; vinylaryldialkylamines such as vinylbenzyldialkylamines; vinyl-N-heterocyclic amines such as vinyl pyridines (for example, 2-vinyl pyridine and 4-vinyl pyridine); vinyl pyrimidines; and vinyl imidazoles (for example, 1-vinyl imidazole and 2-methyl-1-vinyl imidazole). In the case of vinyl-N-heterocyclic amines, the resulting precursor microparticles will comprise structural units with pendant N-heterocyclic amine rings that may be reacted with a betainisation reagent to form betainised N-heterocyclic ammonium rings.

Examples of preferred monomers having betainisable functional groups that may be used to prepare the precursor microparticles include:
(i) Dialkylaminoalkyl acrylates and alkacrylates of general formula (I):

[H₂C═C(R¹)CO₂R²NR³R⁴]

wherein R¹ is selected from hydrogen and methyl;
R² is a straight chain alkylene moiety having from 2 to 10 carbon atoms or a branched chain alkylene moiety having a main chain having from 2 to 10 carbons atoms and at least one branched chain having from 2 to 10 carbon atoms with the proviso that the straight or branched chain alkylene moiety is optionally substituted by methyl; R³ and R⁴ are independently selected from methyl, ethyl, n-propyl and isopropyl, or N, R³ and R⁴ together form an N-heterocyclic amine ring, optionally, having an oxygen heteroatom, for example, a morpholine (or morpholino) or piperidine (or piperidyl) ring;
(ii) Dialkylaminoalkyl acrylamides and alkacrylamides of the formula (II):

[H₂C═C(R¹)CONHR²NR³R⁴]

wherein R¹, R², R³ and R⁴ are as defined above;
(iii) Vinylbenzyldialkylamines of the general formula (III):

[H₂C═C(R¹)C₆H₄R²NR³R⁴]

wherein R′, R², R³ and R⁴ are as defined above; and
(iv) Vinylbenzyldialkylamines analogous to those of general formula (III) in which the benzyl group has from one to three substituents selected from methyl, ethyl, halogen, alkoxy and nitro groups.

Examples of preferred dialkylamine acrylates and alkacrylates of general formula (I) that may be used in the synthesis of the precursor microparticles in accordance with the present invention include:
3-(dimethylamino)propyl methacrylate [H₂C═C(CH₃)CO₂(CH₂)₃N(CH₃)₂];
3-(diethylamino)propyl acrylate [H₂C═CHCO₂(CH₂)₃N(CH₂CH₃)₂];
3-(diethylamino)propyl methacrylate [H₂C═C(CH₃)CO₂(CH₂)₃N(CH₂CH₃)₂];
3-(diisopropylamino)propyl acrylate [H₂C═CHCO₂(CH₂)₃N(CH(CH₃)₂)₂]; and
3-(diisopropylamino)propyl methacrylate [H₂C═C(CH₃)CO₂(CH₂)₃N(CH(CH₃)₂)₂].
2-(dimethylamino)ethyl acrylate [H₂C═CHCO₂(CH₂)₂N(CH₃)₂];
2-(dimethylamino)ethyl methacrylate [H₂CC(CH₃)CO₂(CH₂)₂N(CH₃)₂];
2-(diethylamino)ethyl methacrylate [H₂CC(CH₃)CO₂(CH₂)₂N(CH₂CH₃)₂];
2-(diisopropylamino)ethyl methacrylate [H₂C═C(CH₃)CO₂(CH₂)₂N(CH(CH₃)₂)₂];
2-(piperidin-1-yl)ethyl methacrylate;
2-(piperidin-1-yl)ethyl acrylate;
2-morpholinoethyl methacrylate; and
2-morpholinoethyl acrylate.

Examples of preferred dialkylamino acrylamides and alkacrylamides of general formula (II) that may be used in the synthesis of the precursor microparticles in accordance with the present invention include:
3-(dimethylamino)propyl acrylamide [H₂C═CHCONH(CH₂)₃N(CH₃)₂];
3-(dimethylamino)propyl methacrylamide [H₂C═C(CH₃)CONH(CH₂)₃N(CH₃)₂];
3-(diethylamino)propyl acrylamide [H₂C═CHCONH(CH₂)₃N(CH₂CH₃)₂];
3-(diethylamino)propyl methacrylamide [H₂C═C(CH₃)CONH(CH₂)₃N(CH₂CH₃)₂];
2-(dimethylamino)ethyl acrylamide [H₂C═CHCONH(CH₂)₂N(CH₃)₂];
2-(dimethylamino)ethyl methacrylamide [H₂C═C(CH₃)CONH(CH₂)₂N(CH₃)₂];
2-(diethylamino)ethyl acrylamide [H₂C═CHCONH(CH₂)₂N(CH₂CH₃)₂];
2-(diethylamino)ethyl methacrylamide [H₂C═C(CH₃)CONH(CH₂)₂N(CH₂CH₃)₂];
2-(piperidin-1-yl)ethyl methacrylamide;
2-(piperidin-1-yl)ethyl acrylamide;
2-morpholinoethyl methacrylamide; and
2-morpholinoethyl acrylamide.

Examples of preferred vinylbenzyldialkylamines of general formula (III) include:
N-(4-vinylbenzyl)-N,N-dimethylamine [H₂C═CHC₆H₄CH₂N(CH₃)₂];
N-(4-vinylbenzyl)-N,N-diethylamine [H₂C═CHC₆H₄CH₂N(CH₂CH₃)₂]; and
N-(4-vinylbenzyl)-N,N-diisopropylamine [H₂C═CHC₆H₄CH₂N(CH(CH₃)₂)₂].

The person skilled in the art will understand that the structural units derived from the “cross-linking monomers” form covalent linkages between two polymer chains and/or between different regions of the same polymer chain. These structural units are included in the polymeric microparticles of the present invention to constrain the microparticle conformation at temperatures above the transition temperature thereby preventing the polymer chains from dissolving in the water contained in the pore space of the thief zone(s). Accordingly, the structural units derived from the “cross-linking monomer” are non-labile, i.e., are not degraded under the reservoir conditions, for example, are not degraded at the temperature of the thief zone(s) or at the pH of the water contained within the pore space of the thief zone(s).

Examples of crosslinking monomers that may be used to prepare the precursor microparticles include diacrylamides and methacrylamides of diamines such as the diacrylamide or dimethacrylamide of piperazine or diacrylamide or dimethacrylamide of methylenediamine; methacrylate esters of di, tri, tetra hydroxy compounds including ethyleneglycol dimethacrylate, polyethyleneglycol dimethacrylate, trimethylolpropane trimethacrylate, and the like; divinylbenzene, 1,3-diisopropenylbenzene, and the like; the vinyl or allyl esters of di or trifunctional acids; and, diallylamine, triallylamine, divinyl sulfone, diethyleneglycol diallyl ether, and the like. Preferred non-labile cross linking monomers include methylene bisacrylamide and divinylbenzene.

Preferably, the crosslinking monomer comprises from 0.1 to 10 mol %, more preferably 0.5 to 3 mol %, for example, 1 to 2 mol % of the mixture of monomers used to prepare the precursor microparticles.

Examples of hydrophobic comonomers (without betainisable functional groups) that may optionally be used to prepare the precursor microparticles include: benzyl methacrylate, benzyl acrylate, benzyl acrylamide, benzyl methacrylamide, n-butyl methacrylate, n-butyl acrylate, n-butyl acrylamide, n-butyl methacrylamide, and the like; and styrenic monomers substituted with branched alkyl, straight chain alkyl or aryl groups. Such hydrophobic comonomers are believed to modify the transition temperature of the microparticles.

Suitably, the hydrophobic comonomer(s) may comprise up to 50 mol % of the mixture of monomers used to prepare the precursor microparticles.

In accordance with a preferred embodiment of the invention, the precursor microparticles may be prepared by an emulsion polymerization process in order to control the particle size distribution of the precursor microparticles. An emulsion polymerisation process is a polymerization process in which water-insoluble monomers (or a solution of water-insoluble monomers in an oil phase) are added to an aqueous phase containing a stabilizer that stabilizes the emulsion. The resulting emulsion consists of a discontinuous phase (also referred to as “disperse phase”) comprising small droplets of water-insoluble monomers (or a solution of water-insoluble monomers in an oil phase), dispersed in a continuous aqueous phase wherein the droplets typically have a diameter of greater than 100 nm (0.1 micron).

Where the water-insoluble monomers are optionally dissolved in an oil phase, the oil phase preferably comprises a saturated liquid hydrocarbon or a mixture thereof. Suitable hydrocarbon liquids for use as the continuous hydrocarbon phase of the emulsion include benzene, toluene, cyclohexane, and mixtures thereof.

Suitable stabilizers for forming the emulsion include non-reactive and reactive stabilizers.

Examples of non-reactive stabilizers include surfactants such as sorbitan esters of fatty acids, ethoxylated sorbitan esters of fatty acids, alkyl sulfates, alkyl ether sulfates, alkyl betaine surfactants, for example, alkyl sulfobetaine surfactants or mixtures thereof. Examples of preferred non-reactive surfactants include ethoxylated sorbitol oleate, sorbitan sesquioleate, and sodium dodecylsulfate (SDS).

Examples of reactive stabilizers include any water-soluble polymeric or oligomeric stabilizer having a polymerisable end group such that the stabilizer becomes incorporated in the precursor microparticles. Suitably, the polymerisable end group may be selected from acrylate, methacrylate, acrylamide, methacrylamide, styrenic, activated vinyl, dithiobenzoate and trithiocarbonate end groups. Suitable reactive surfactants include polyethyleneglycol acrylates (PEGA); polyethyleneglycol methacrylates (PEGMA); and, poly(N,N′-dimethyl(methacryloylethyl)ammonium propane sulfonate) (PDMAPS) having a dithiobenzoate or trithiocarbonate end group.

Where a reactive stabilizer with a polymerisable end group (i.e. a monomer with surfactant properties) is used in the synthesis of the precursor microparticles, preferably, the reactive stabilizer comprises from 0.5 to 10 weight % of the total weight of monomers used to prepare the precursor microparticles.

The polymerization process, for example, the emulsion polymerization process, may be initiated using a thermal or redox free-radical initiator. Suitable initiators include azo compounds, such as azobisisobutyronitrile (AIBN) and 4,4′-azobis(4-cyanovaleric acid) (ACVA); peroxides, such as di-t-butyl peroxide; inorganic compounds, such as potassium persulfate; and, redox couples, such as benzoyl peroxide/dimethylaminopyridine and potassium persulfate/sodium metabisulfite.

Preferably, the polymerization initiator comprises from 0.01 to 10 mol % of the mixture of monomers used to prepare the precursor microparticles.

In addition to the monomers, cross-linkers, polymerization initiator and stabilizer(s), other conventional additives may be used in the synthesis of the precursor microparticles, for instance pH adjusters, and chelating agents used to remove polymerization inhibitors.

Where the precursor microparticles of the invention are prepared by emulsion polymerization, the precursor microparticles may be obtained in dry form by precipitation from the emulsion using a suitable solvent, such as isopropanol, acetone, isopropanol/acetone or methanol/acetone or other solvents or solvent mixtures that are miscible with both the hydrocarbon and water. The precursor microparticles may be isolated from the supernatant by centrifugation and/or filtration and dried by conventional procedures.

Suitable procedures for the preparation of the precursor microparticles using emulsion polymerization processes are available in the art, and reference in this regard is made to U.S. Pat. Nos. 4,956,400, 4,968,435, 5,171,808, 5,465,792 and 5,737,349.

It is also envisaged that other polymerisation methods may be used to prepare the precursor microparticles such as dispersion polymerization methods. Suitable procedures for the preparation of the precursor microparticles using dispersion polymerization processes are available in the art, and reference in this regard is made to Sanson, N.; Rieger, J. Polymer Chemistry 2010, 1, 965.

As used herein, the term “betainised microparticles” refers to microparticles wherein at least a portion of the pendant groups comprising betainisable functional groups of the precursor microparticles have been reacted with a betainising reagent thereby forming betainised functional groups containing both a cationic quaternary ammonium group (derived from the betainisable functional group) and an anionic functional group (derived from the betainising reagent). As discussed above, the betainising reagent may be a sulfobetainising reagent, carboxybetainising reagent, phosphobetainising reagent, phosphonobetainising reagent, sulfabetainising reagent, or mixtures thereof.

As used herein, the terms “sulfobetainised microparticles”, “carboxybetainised microparticles”, “phosphobetainised microparticles”, “phosphonobetainised microparticles” and “sulfabetainised microparticles” refer to microparticles wherein at least a portion of the pendant groups comprising betainisable functional groups of the precursor microparticles have been converted to sulfobetainised, carboxybetainised, phosphobetainised, phosphonobetainised and sulfabetainised functional groups respectively that contain both a cationic quaternary ammonium group (derived from the betainisable functional group) and an anionic functional group (derived from the betainising reagent).

Preferably, the betainised microparticles of the present invention are sulfobetainised or sulfabetainised microparticles.

Examples of preferred sulfobetainised groups include (2-sulfoethyl)-ammonium betaine groups, (3-sulfopropyl)-ammonium betaine groups, and (4-sulfobutyl)-ammonium betaine groups.

Examples of preferred phosphobetainised groups include (2-phosphoethyl)-ammonium betaine groups, (3-phosphopropyl)-ammonium betaine groups, and (4-phosphobutyl)-ammonium betaine groups.

Examples of preferred phosphonobetainised groups include “phosphono” equivalents of the above preferred phosphobetainised groups.

Examples of preferred carboxybetainised groups include (2-carboxyethyl)-ammonium betaine groups, (3-carb oxypropyl)-ammonium betaine groups, and (4-carboxybutyl)-ammonium betaine groups.

Examples of preferred sulfabetainised groups include (2-sulfaethyl)-ammonium betaine groups, (3-sulfapropyl)-ammonium betaine groups, and (4-sulfabutyl)-ammonium betaine groups. The “sulfa” group is defined herein as an —OSO₃⁻ group (also referred to in the art as a “sulfate” group).

In a further aspect of the present invention, there is provided betainised microparticles comprising crosslinked polymer chains having pendant groups comprising betainised functional groups and, optionally, pendant groups comprising unreacted betainisable functional groups wherein the betainised functional groups are present in the microparticles in an amount of at least 20% (based on the total amount of betainised and unreacted betainisable functional groups).

Preferably, at least 25%, more preferably, at least 50% of the betainisable functional groups may be betainised, in particular, sulfobetainised (based on the total amount of betainised and unreacted betainisable functional groups). Suitably, from 25 to 100%, preferably from 50 to 95% of the betainisable functional groups of the precursor microparticles may be betainised (based on the total amount of betainised and unreacted betainisable functional groups).

The precursor microparticles may be converted to sulfobetainised microparticles by reaction of at least a portion of its betainisable functional groups with a sulfobetainising reagent selected from cyclic sultones such as 1,3 propane sultone or 1,4 butane sultone.

The precursor microparticles may be converted to carboxybetainised microparticles by reaction of at least a portion of its betainisable functional groups with a cyclic carboxybetainising reagent selected from lactones, for example, (3-propiolactone.

The precursor microparticles may be converted to phosphobetainised microparticles by reaction of at least a portion of its betainisable functional groups with a cyclic phosphobetainising reagent selected from dioxaphospholane oxides, for example, alkoxy dioxaphospholane oxides such as 2-methoxy-1,3,2-dioxaphospholane 2-oxide, 2-ethoxy-1,3,2-dioxaphospholane 2-oxide, 2-propoxy-1,3,2-dioxaphospholane 2-oxide, and 2-butoxy-1,3,2-dioxaphospholane 2-oxide.

The precursor microparticles may be converted to sulfabetainised microparticles by reaction of at least a portion of its betainisable functional groups with a cyclic sulfabetainising reagent selected from dioxathiolane dioxides and dioxathiane dioxides, for example, 1,3,2-Dioxathiolane 2,2-dioxide, 4-Methyl-1,3,2-dioxathiolane-2,2-dioxide and 1,3,2-Dioxathiane 2,2-dioxide.

Typically, the reaction with the cyclic betainising reagent (in particular, a cyclic sultone) may be performed by dispersing the precursor microparticles in a mixture of water and a water-miscible solvent, for example, tetrahydrofuran (THF) (for example, a 0.5:1 to 1:0.5, in particular, a 1:1 mixture of water and THF by volume) and heating the resulting dispersion at an elevated temperature for a sufficient period of time to achieve a desired percentage betainisation of the betainisable functional groups. The solvent may be subsequently removed from the dispersion by, for example, dialysis, cross-flow ultrafiltration or evaporation.

Typically, the reaction with the cyclic betainising reagent (in particular, a cyclic sultone) may be performed at a temperature in the range of 25 to 80° C. Typically, the duration of the reaction is up to 48 hours.

The precursor microparticles may also be converted to betainised microparticles by reaction of at least a portion of its betainisable functional groups with a betainising reagent having a halide leaving group. Typically, the betainising reagent having the halide leaving group is of general formula V:

XRA⁻M⁺

wherein X is a halogen selected from F, Cl, Br and I, preferably, Cl and Br;
R is a hydrocarbylene group having up to 30 carbon atoms wherein the hydrocarbylene group may be selected from: branched or unbranched alkylene groups; arylene groups; alkarylene groups (an alkyl substituted arylene group wherein the alkyl substituent may be branched or unbranched); and arylalkylene groups (an aryl substituted alkylene group where the alkylene group may be branched or unbranched); and wherein the alkylene, arylene, alkarylene or arylalkylene groups may be optionally substituted with functional groups selected from hydroxyl, ether, ester, amide, and the like;
A⁻ is an anionic functional group selected from SO₃⁻ (sulfonate), PO₃⁻ (phosphonate), OPO₃⁻ (phosphate), CO₃⁻ (carboxylate) and OSO₃⁻ (ether sulfonate; also referred to as sulfate) functional groups, preferably, SO₃⁻ (sulfonate) functional groups; and
M⁺ is selected from H⁺, Group IA metal cations and ammonium cations.

Preferably, the betainising reagent having the halide leaving group is selected from betainising agents of formula Va:

XCH₂(CH₂)CH₂A⁻M⁺

wherein X, A⁻ and M⁺ are as defined above; and
n is an integer in the range of 0 to 20, preferably 0 to 10, in particular, 0 to 3.

Typically, the reaction with the betainising reagent having the halide leaving group may be performed by dispersing the precursor microparticles in a mixture of water and a water-miscible solvent in the presence of a water-soluble base that has a higher basicity than the betainisable functional groups of the precursor microparticles, and heating the resulting dispersion at an elevated temperature for a sufficient period of time to achieve the desired percentage betainisation of the betainisable functional groups. The water-miscible solvent and halide salt side product may be subsequently removed from the dispersion by, for example, dialysis or cross-flow ultrafiltration.

The water-miscible solvent may be acetonitrile, dimethylformamide (DMF), an alcohol (in particular, ethanol, n-propanol or isopropanol) with the exception of methanol as this reacts with the haloalkyl sulfonates or haloalkylsulfonic acids, or any other water-miscible solvent. Preferably, the ratio of water to water-miscible solvent in the solvent mixture is from 0.5:1 to 1:0.5 by volume, in particular, 1:1 by volume. Preferably, the water-miscible base is selected from sodium hydroxide, potassium hydroxide and ammonium hydroxide.

Typically, the reaction with the betainising reagent (in particular, a haloalkyl sulfonate or sulfonic acid) may be performed at a temperature in the range of 25 to 100° C., for example, 50 to 100° C. Typically, the duration of the reaction is up to 48 hours.

Preferred haloalkyl sulfonates include sodium 2-bromoethane sulfonate, sodium 2-chloroethane sulfonate, sodium 3-bromopropane-1-sulfonate, sodium 3-chloropropane-1-sulfonate, sodium 4-bromobutane-1-sulfonate, sodium 4-chlorobutane-1-sulfonate, sodium 5-bromopentane-1-sulfonate, sodium 5-chloropentane-1-sulfonate, sodium 6-bromohexane-1-sulfonate, sodium 6-chlorohexane-1-sulfonate, and hydroxyhaloalkyl sulfonates such as sodium 3-chloro-2-hydroxy-1-propane sulfonate or sodium 4-chloro-1-hydroxy-1-butane sulfonate.

Preferred haloalkyl sulfonic acids and hydroxyalkyl sulfonic acids include the corresponding acids of the above preferred haloalkyl sulfonates and hydroxyhaloalkyl sulfonates.

Preferred haloalkyl phosphonates include sodium 2-bromoethane phosphonate, sodium 2-chloroethane phosphonate sodium 3-bromopropane-1-phosphonate, sodium 3-chloropropane-1-phosphonate, sodium 4-bromobutane-1-phosphonate, sodium 4-chlorobutane-1-phosphonate, sodium 5-bromopentane-1-phosphonate, sodium 5-chloropentane-1-phosphonate, sodium 6-bromohexane-1-phosphonate, sodium 6-chlorohexane-1-phosphonate, and hydroxyhaloalkyl phosphonates such as sodium 3-chloro-2-hydroxy-1-propane phosphonate or sodium 4-chloro-1-hydroxy-1-butane phosphonate.

Preferred haloalkyl phosphonic acids and hydroxyhaloalkyl phosphonic acids include the corresponding acids of the above preferred haloalkyl phosphonates and hydroxyhaloalkyl phosphonates.

Preferred haloalkyl phosphates include sodium 2-bromoethane phosphate, sodium 2-chloroethane phosphate, sodium 3-bromopropane-1-phosphate, sodium 3-chloropropane-1-phosphate, sodium 4-bromobutane-1-phosphate, sodium 4-chlorobutane-1-phosphate, sodium 5-bromopentane-1-phosphate, sodium 5-chloropentane-1-phosphate, sodium 6-bromohexane-1-phosphate, sodium 6-chlorohexane-1-phosphate, and hydroxyhaloalkyl phosphates such as sodium 3-chloro-2-hydroxy-1-propane phosphate or sodium 4-chloro-1-hydroxy-1-butane phosphate.

Preferred haloalkyl phosphoric acids and hydroxyhaloalkyl phosphoric acids include the corresponding acids of the above preferred haloalkyl phosphates and hydroxyhaloalkyl phosphates.

Preferred haloalkyl carboxylates include sodium iodoacetate (sodium 2-iodoacetate), sodium 2-bromoethane carboxylate, sodium 2-chloroethane carboxylate, sodium 3-iodopropane-1-carboxylate, sodium 3-bromopropane-1-carboxylate, sodium 3-chloropropane-1-carboxylate, sodium 4-iodobutane-1-carboxylate, sodium 4-bromobutane-1-carboxylate, sodium 4-chlorobutane-1-carboxylate, sodium 5-iodopentane-1-carboxylate, sodium 5-bromopentane-1-carboxylate, sodium 5-chloropentane-1-carboxylate, sodium 6-iodoheance-1-carboxylate, sodium 6-bromohexane-1-carboxylate, sodium 6-chlorohexane-1-carboxylate, and hydroxyhaloalkyl carboxylates such as sodium 3-chloro-2-hydroxy-1-propane carboxylate or sodium 4-chloro-1-hydroxy-1-butane carboxylate.

Preferred haloalkyl carboxylic acids and hydroxyhaloalkyl carboxylic acids include the corresponding acids of the above preferred haloalkyl carboxylates and hydroxyhaloalkyl carboxylates.

Preferred haloalkylether sulfonates include sodium 2-bromoethane sulfonate, sodium 2-chloroethane sulfonate, sodium 3-bromopropylether-1-sulfonate, sodium 3-chloropropylether-1-sulfonate, sodium 4-bromobutylether-1-sulfonate, sodium 4-chlorobutyl ether-1-sulfonate, sodium 5-bromopentylether-1-sulfonate, sodium 5-chloropentylether-1-sulfonate, sodium 6-bromohexyl ether-1-sulfonate, sodium 6-chlorohexyl ether-1-sulfonate, and hydroxy alkyl ether sulfonates such as sodium 3-chloro-2-hydroxy-1-propylether sulfonate or sodium 4-chloro-1-hydroxy-1-butylether sulfonate.

Preferred haloalkylether sulfonic acids and hydroxyhaloalkyl sulfonic acids include the corresponding acids of the above preferred haloalkylether sulfonates and hydroxyhaloalkylether sulfonates. The haloalkylether sulfonates and hydroxyhaloalkylether sulfonates are also referred to in the art as haloalkyl sulfates and hydroxyhaloalkyl sulfates.

It is to be understood that the corresponding lithium, potassium or ammonium salts of the above preferred betainising reagents of formula Va may also be used to prepare the betainised microparticles.

The composition according to the present invention may be prepared by dispersing the betainised microparticles in an aqueous fluid (for example, an injection water available at the injection site) at a temperature below the transition temperature of the betainised microparticles, thereby forming a dispersion of the betainised microparticles in the aqueous fluid. Agitation means, for example sonication or stirring (for example, using paddle stirrers), may be used to promote the formation of a stable dispersion.

The composition may also be prepared from a concentrate comprising the betainised microparticles at a higher concentration in an aqueous fluid than is intended for the injected composition. The concentrate may then be dosed into an injection water, for instance injection water located at the injection site, in order to prepare the composition that is to be injected into the thief zone of the reservoir.

Where the betainised microparticle composition is formed by dispersing dried betainised microparticles in an aqueous fluid, the betainised microparticles may be dispersed in a water-miscible organic solvent to form a concentrated dispersion of the betainised microparticles in the water-miscible organic solvent which is subsequently diluted into the aqueous fluid. Suitable water-miscible solvents include tetrahydrofuran, 1,3-butylene glycol, tetrahydrofurfuryl alcohol, ethylene glycol monobutyl ether, ethylene glycol methyl ether, mono ethylene glycol, and methyl ethyl ketone. Optionally, the water-miscible solvent may be subsequently removed from the diluted dispersion via a cross-flow ultrafiltration process, by a dialysis process or by evaporation.

If desired, a surfactant dispersant or a mixture of surfactant dispersants may be used to assist in dispersing either the dried betainised microparticles or the concentrated dispersion of the betainised microparticles in the aqueous fluid (injection water). Suitable surfactant dispersants are well known to the person skilled in the art and include sodium dodecylsulfate, nonylphenylethoxylates, polyoxyethylene-20-sorbitan monooleate, nonionic ethylene oxide/propylene oxide block copolymer surfactants, and zwitterionic surfactants such as cocamidopropyl hydroxysultaine and, in particular, betaine surfactants such as cocamidopropylbetaine.

The aqueous fluid may be any water suitable for injection into a subterranean formation via an injection well. For instance, the aqueous fluid may be fresh water, lake water, river water, estuarine water, brackish water, seawater, aquifer water, desalinated water, produced water or mixtures thereof.

As the skilled person will appreciate, the composition may also be prepared by separately adding the surfactant dispersant(s) and betainised microparticles in the aqueous fluid. In that case, the surfactant(s) are typically added to the aqueous fluid prior to addition of the betainised microparticles.

The person skilled in the art will recognize that the physical properties of the betainised microparticles, for example, their size, dispersivity and transition temperature, may be tailored to the conditions encountered in the thief zone of the reservoir.

The particle size distribution of the precursor microparticles and hence the particle size distribution of the betainised microparticles may be varied by varying the size of the emulsion droplets in the emulsion polymerization process used to prepare the precursor microparticles.

This may be achieved by varying the stirring method or stirrer speed used in the emulsion polymerization process. Suitable methods of stirring the emulsion include the use of magnetic stirrers or paddle stirrers. The particle size distribution may also be varied by varying the stabilizer (surfactant), dispersion medium, water-insoluble monomer and the concentration of monomers used in the emulsion polymerization process. Such methods of varying the particle size distribution are well known to the person skilled in the art.

The dispersivity of the betainised microparticles may be varied by changing the surfactant used in the preparation of the precursor microparticles and/or the surfactant employed when dispersing the betainised microparticles or concentrate comprising the betainised microparticles in the aqueous fluid.

The transition temperature of the betainised microparticles may be varied by varying one or more of: the mol % of any hydrophobic comonomer used to prepare the precursor microparticles; the chemical structure of the betainisable functional groups, for example, dialkylaminoalkylene functional groups; the chemical structure of the linker group of the betainising reagent (linking the cationic and anionic groups); and, the percentage betainisation of the microparticles.

Typically, the transition temperature of the betainised microparticles in nanopure water increases with increasing percentage betainisation of the betainisable functional groups of the precursor microparticles. For example, with a target percentage betainisation of the betainisable functional groups of the precursor microparticles of 50, 75 and 100%, the betainised microparticles begin to swell or expand at temperatures of about 25, 40 and 60° C. respectively when dispersed in nanopure water. Without wishing to be bound by any theory, the transition temperature increases with increasing salinity of the water in which the microparticles are dispersed. The person skilled in the art will understand that the injected composition (i.e. a dispersion of the microparticles in an injection water) may mix with the formation water contained within the pore space of the thief zone such that the transition temperature of the microparticles may be dependent upon both the salinity of the injection water and the salinity of the formation water. The target percentage betainisation may therefore be varied depending on the salinity to which the microparticles are exposed within the thief zone. The salinity to which the microparticles are exposed in the thief zone may be estimated by modelling dispersive mixing of the injected composition with the formation water, for example, using a reservoir simulator such as STARS™.

Typically, the degree of expansion of the betainised microparticles may be varied by varying the extent of crosslinking of the precursor microparticles, and the percentage betainisation of the precursor microparticles.

The extent to which the betainised microparticles aggregate or flocculate at temperatures above the transition temperature may be dependent upon the percentage betainisation of the betainisable functional groups. Thus, it has been found that betainised microparticles having a percentage betainisation of the betainisable functional groups of less than 95%, tend to form aggregates at temperatures above the transition temperature while microparticles having a percentage betainisation of 95% or above do not tend to form aggregates at temperatures above the transition temperature. It is preferred that the betainised microparticles have a percentage betainisation of the betainisable functional groups of less than 75% as this increases the tendency of the microparticles to aggregate at temperatures above the transition temperature.

It has also been found that the transition temperature of the betainised microparticles increases with increasing carbon chain length of the alkylene group that links the ammonium and anionic groups of the betaine functional groups of the betainised microparticles. Typically, there is at least a 5° C. increase in the transition temperature at which the betainised particles begin to expand in size with each additional carbon atom in the hydrocarbylene linker group of the betaine functional groups.

The composition of the present invention is preferably injected into a thief zone of a reservoir in an amount that is suitable to reduce the permeability of a thief zone to water. The skilled person could determine a suitable amount which will be dependent upon the pore volume of the thief zone. As the skilled person will appreciate, the amount of the composition that is required may also be dependent on the concentration of the betainised microparticles in the aqueous fluid. Thus, the required pore volume of the composition will decrease with increasing concentration of the betainised microparticles dispersed in the aqueous fluid.

Suitably, the dispersion comprising betainised crosslinked polymeric microparticles dispersed in an aqueous fluid is injected into the reservoir in a pore volume amount in the range of 0.05 to 1, preferably 0.2 to 0.5, typically about 0.3 PV.

The term “pore volume” is used herein to mean the “effective pore volume” between an injection well and a production well. The “effective pore volume” is the interconnected pore volume or void space in a rock that contributes to fluid flow or permeability in a reservoir. Effective pore volume excludes isolated pores and pore volume occupied by water adsorbed on clay minerals or other grains. Effective pore volume may be determined using techniques well known to the person skilled in the art such as from reservoir modelling or reservoir engineering calculations.

Preferably, the composition comprising betainised microparticles dispersed in an aqueous fluid comprises from 0.01 to 20% by weight, more preferably, from 0.01 to 10% by weight, yet more preferably from 0.02 to 5% by weight, and most preferably from 0.05 to 3% by weight of betainised microparticles based on the total weight of the composition.

According to the process of the present invention, the composition of the present invention is injected down an injection well and into a thief zone so as to reduce the permeability of the thief zone to water. Initial expansion of the betainised microparticles may occur in a single location in a thief zone or at a plurality of locations. For instance, different forms or grades of betainised microparticles may be present in a single composition according to the present invention. These different grades of betainised microparticles may undergo expansion at different transition temperatures. In turn, expansion of the different grades of microparticles may occur in the thief zone at different locations having different temperatures, thereby reducing the permeability of the thief zone to water at a plurality of locations. In an embodiment, the composition of the present invention may be used to reduce the permeability of a plurality of thief zones.

The well into which the composition of the present invention is injected may be an injection well or a production well. Where the composition of the present invention is injected into a production well, the well is taken off production prior to injection of the composition.

The transition temperature of the betainised microparticles should be greater than the maximum temperature encountered in the well into which the composition comprising the microparticles is injected. It will be understood that by using betainised microparticles having a transition temperature which is greater than the maximum temperature encountered in the well, expansion of the microparticles before they enter the thief zone may be avoided. The maximum temperature encountered in a particular well may be readily determined by the skilled person.

The transition temperature of the betainised microparticles should also be at or below the maximum temperature encountered in the thief zone such that the microparticles expand within the thief zone of the reservoir. The person skilled in the art will understand that the temperature of the thief zone of the reservoir may vary with increasing radial distance from the well into which the composition comprising the temperature sensitive betainised microparticles is injected. For example, in reservoirs where a waterflood has already taken place, the previously injected water typically has a temperature significantly below the original temperature of the reservoir and therefore injection of the water results in a temperature gradient across the reservoir, i.e., the injection of cold water has a cooling effect in the vicinity of the injection well and for some distance beyond it. Thus, typically, there is a temperature front in various layers of the reservoir at a radial distance from the injection well with the temperature front advancing through the layers of the reservoir over time. Thus, although the original temperature of the reservoir may be in the range of 80 to 140° C., substantial cooling of the layers of the reservoir, and hence the thief zone or zones, may have occurred during a waterflood. Typically, the temperature of the reservoir in the cooled region of the thief zone or zones (behind the temperature front) may be in the range of 20 to 120° C., for example, 25 to 120° C. Generally, the temperature in the cooled region of the thief zone or zones is 10 to 60° C. below, for example, 20 to 50° C. below the original reservoir temperature. Accordingly, the temperature at which expansion of the dispersed betainised microparticles is induced (i.e. the transition temperature) may be significantly less than the original reservoir temperature (prior to waterflooding). The person skilled in the art will understand that the extent of any cooling of the thief zone in the near wellbore region of a production well is likely to be less than the extent of any cooling of the thief zone in the near wellbore region of an injection well. Preferably, the transition temperature of the betainised microparticles is at or slightly below (e.g. less than 30° C. below, preferably less than 20° C. below and more preferably less than 10° C. below) the maximum temperature encountered in the thief zone, so that the microparticles expand only once they have propagated deep into the thief zone.

The transition temperature of the betainised microparticles employed in the process of the present invention may be readily determined by the person skilled in the art. As discussed above, the transition temperature may be adjusted by appropriate selection of the degree of crosslinking of the precursor microparticles, the % target betainisation, the nature of the betainisable functional groups of the precursor microparticles and the nature of the linker group between the quaternary ammonium cation and the anionic group of the pendant betainised functional groups. Accordingly, dispersions of microparticles may be prepared which have an appropriate transition temperature for the temperatures encountered within the thief zone where it is desired to form a block, or multiple blocks of expanded microparticles.

Once expansion of the betainised microparticles is triggered, it is believed that the expanded microparticles block the pore throats of a region of the thief zone and the flow of subsequently injected water is largely diverted into neighbouring, previously unswept zones of the reservoir. The expanded microparticles that form at or above the transition temperature may be sufficiently large to bridge the pore throats of the thief zone. However, it is preferred that the expanded microparticles form aggregates that block the pore throats of the thief zone. After a period of time, the subsequently injected water flowing through neighbouring zones of the reservoir acts to cool the blocked region of the thief zone to below the transition temperature resulting in the expanded microparticles contracting in size (and de-aggregation of any aggregates) such that the contracted microparticles become redispersed in water. The resulting microparticle dispersion then flows on through the thief zone before forming a subsequent block once a further region of the thief zone having a temperature at or above the transition temperature is reached. In this way, the present invention allows for the formation of multiple, successive blocks within a thief zone such that a greater volume of the reservoir may be swept by subsequently injected water. The net result is that more water passes through the previously unswept zones, with more oil being swept towards the production well, i.e. sweep efficiency is improved.

Where the dispersion is injected from a production well into a thief zone or zones, if necessary, ambient temperature water (for example, seawater, estuarine water, river water, lake water or desalinated water having a temperature of about 3 to 15° C.), may be injected into the thief zone ahead of the composition of the present invention in order to cool the production well and thief zone thereby mitigating the risk of premature expansion of the betainised microparticles.

The thief zone of the reservoir may be a layer of reservoir rock having a permeability greater than the permeability of adjacent hydrocarbon-bearing layers of the reservoir, for example at least 50% greater. For example, the by-passed adjacent hydrocarbon-bearing layers of the reservoir may have a permeability, for example, in the range of 30 to 100 millidarcies while the thief layer may have a permeability, for example, in the range of 90 to less than 6,000 millidarcies, in particular, 90 to 1,000 millidarcies, with the proviso that the thief layer has a permeability at least 3 times greater, preferably, at least 4 times greater than that of the adjacent by-passed layers of the reservoir.

Alternatively, the thief zone of the reservoir may be a layer of reservoir rock having fractures therein that may be up to several hundreds of metres in length. Depending on the temperature of the surrounding rock and on the length of the fracture, the dispersion of the microparticles may penetrate a significant distance into a fracture, for example, to the fracture tip, before encountering the threshold temperature at which the microparticles expand and block the fracture.

Suitably, the betainised microparticles are dispersed in an aqueous fluid having a total dissolved solids (TDS) content in the range of 200 to 250,000 mg/L, preferably, in the range of 500 to 50,000 mg/L, more preferably, 1500 to 35,000 mg/L.

In at least some examples of the process for modifying the permeability to water of a thief zone, the composition comprises a dispersion of the betainised microparticles in seawater, estuarine water, brackish water, lake water, river water, desalinated water, produced water, aquifer water or mixtures thereof, in particular, seawater. By “produced water” is meant water produced in the process of recovering hydrocarbons from the reservoir or in any other process.

Optionally, the composition employed in the method of the present invention may further comprise one or more conventional additives used in enhanced oil recovery, such as viscosifiers, polymers and/or pH adjusters.

Owing to the difference in permeability between thief zones and adjacent hydrocarbon fluid-bearing zones of the reservoir, in the process of the present invention, most of the injected composition of the present invention enters the thief zone. However, if desired, the hydrocarbon fluid-bearing zones of the reservoir may be isolated from the well, for example, packers may be arranged in the well, above and below a thief zone, in order to mitigate the risk of the injected composition entering adjacent hydrocarbon fluid-bearing zones of the reservoir.

In at least some examples of the present invention, the composition of the present invention is injected continuously or intermittently, preferably, continuously, into the reservoir for up to 4 weeks, for example for 5 to 15 days.

The invention will now be demonstrated by reference to the following Examples and Figures.

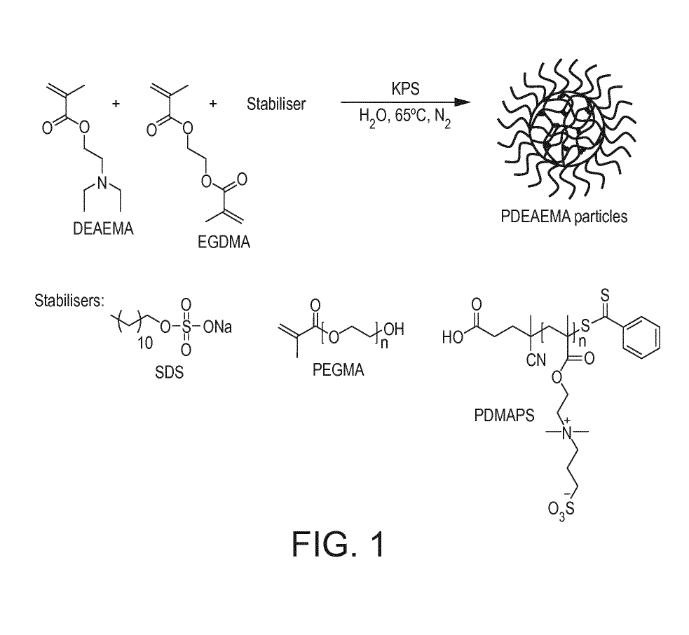

FIG. 1 shows the synthesis of poly(2-(diethylamino)ethyl methacrylate) (PDEAEMA) precursor microparticles using different stabilizers.

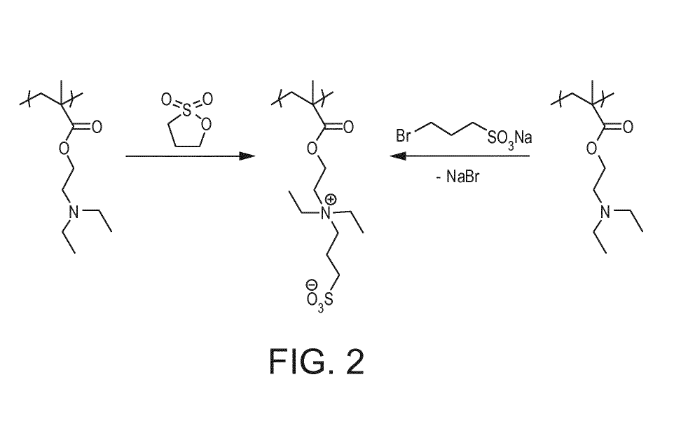

FIG. 2 shows the reactions of dialkylaminoalkylene (betainisable) functional groups of the precursor microparticles with 1,3 propane sultone and with sodium 3-bromopropane-1-sulfonate.

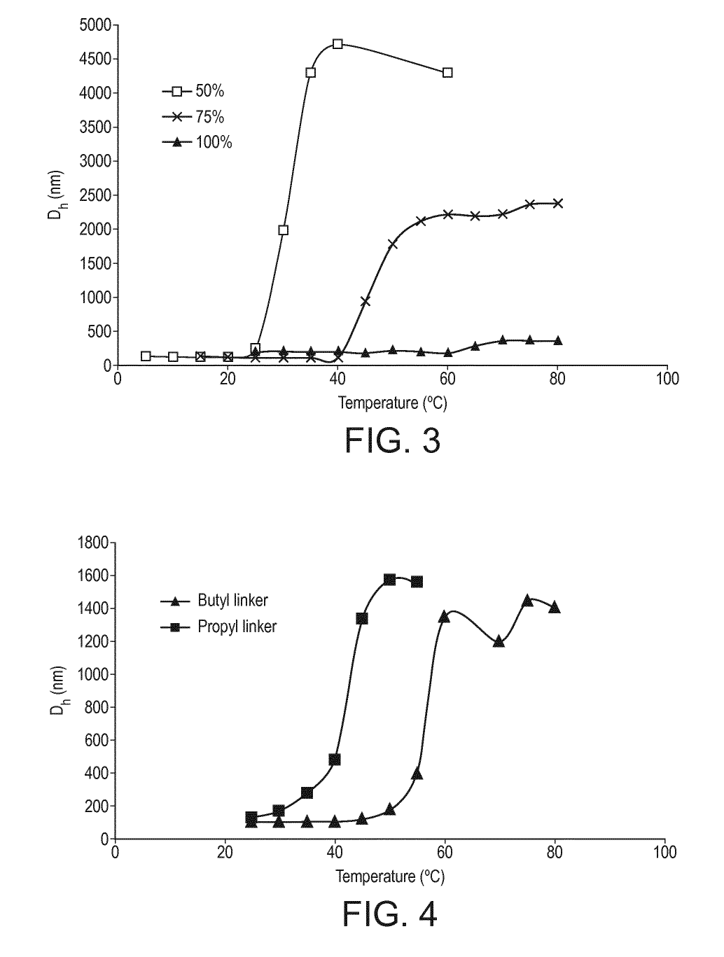

FIG. 3 shows changes in the diameter of sulfobetainised crosslinked microparticles (having 50, 75 and 100% betainisation) with changing temperature when the microparticles are dispersed in ultra-pure water.

FIG. 4 shows changes in the diameter of polysulfobetaine microparticles with changing temperature when the microparticles are dispersed in a 0.3 M sodium chloride solution (for microparticles comprising pendant betainised groups having an n-propyl or n-butyl group linking the ammonium and sulfonate groups).

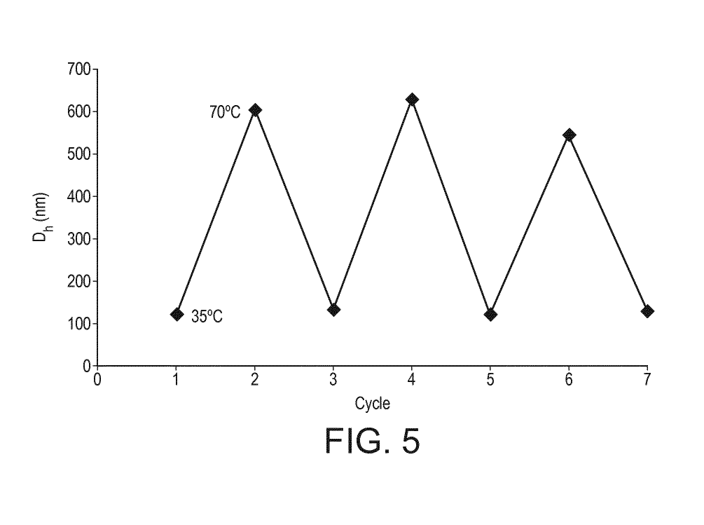

FIG. 5 shows the reversible microparticle expansion and aggregation of polysulfobetaine microparticles in a 0.3M solution of NaCl.

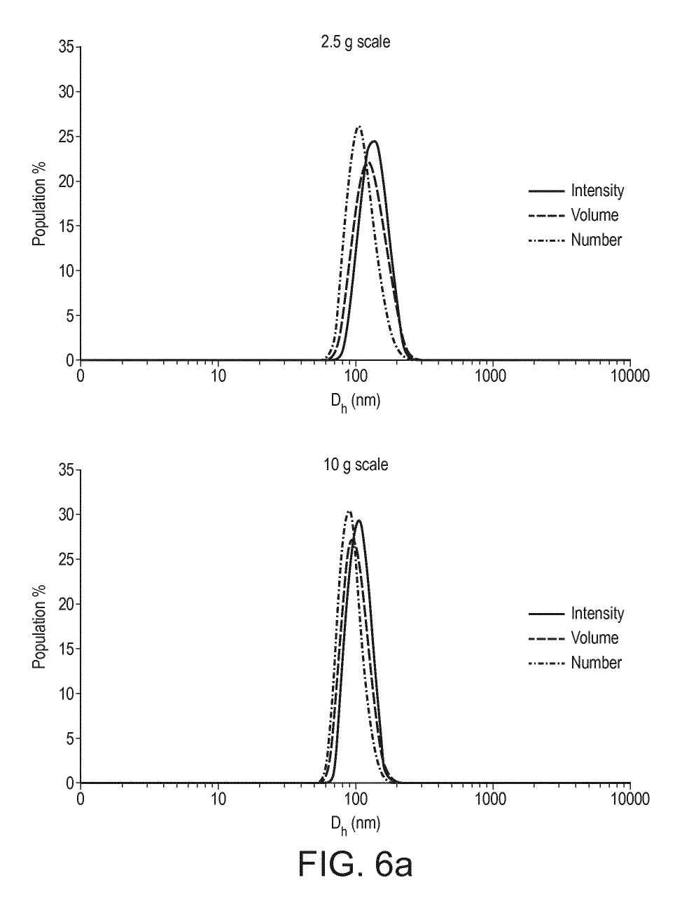

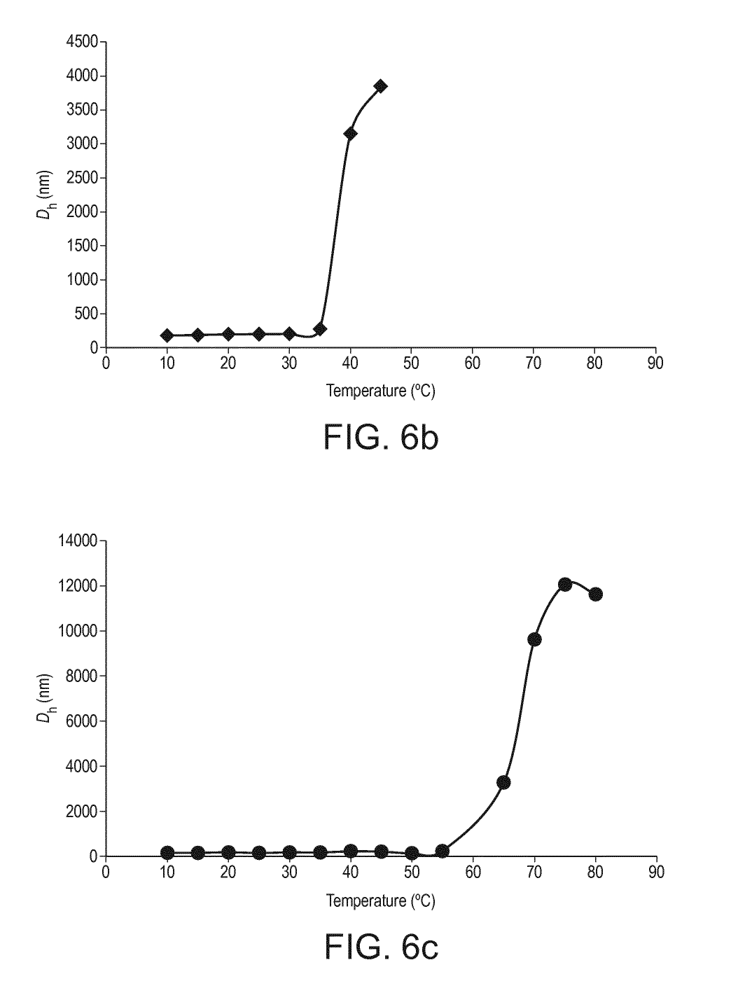

FIG. 6a shows DLS analytical data at a temperature of 25° C. for polysulfobetaine microparticles synthesised at two different scales (10 g and 40 g procedures).

FIG. 6b shows how the hydrodynamic diameter (Dₕ) of hydroxysulfobetainised microparticles change with temperature when dispersed in ultra-pure water having a resistivity of 18.2 MΩ·cm water.

FIG. 6c shows how the hydrodynamic diameter (Dₕ) of carboxybetainised microparticles change with temperature when dispersed in ultra-pure water having a resistivity of 18.2 MΩ·cm water.

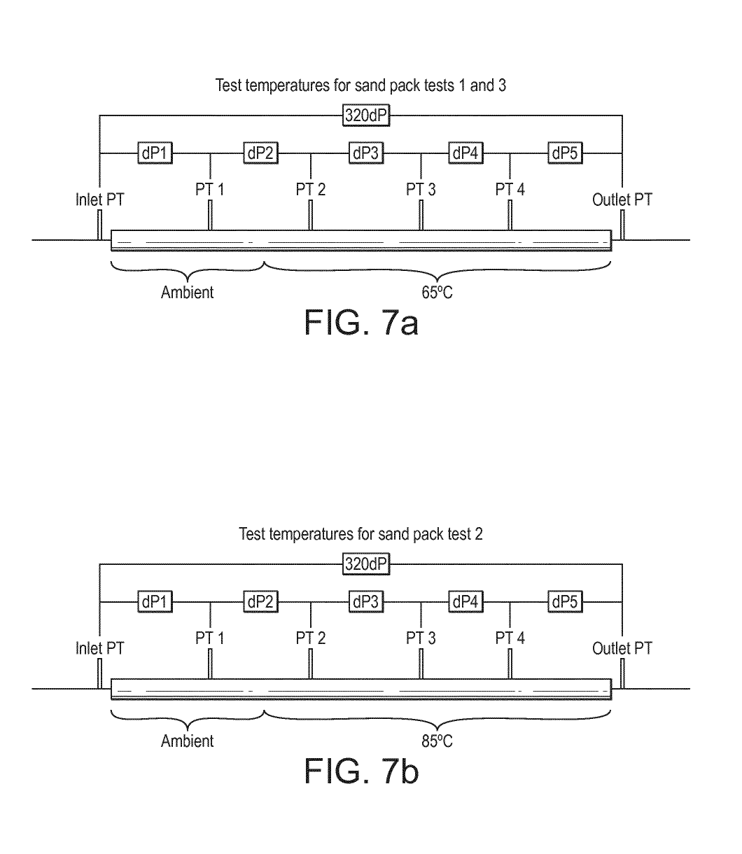

FIGS. 7a and 7b show the test temperatures for sandpack sections for Sandpack Tests 1 to 3.

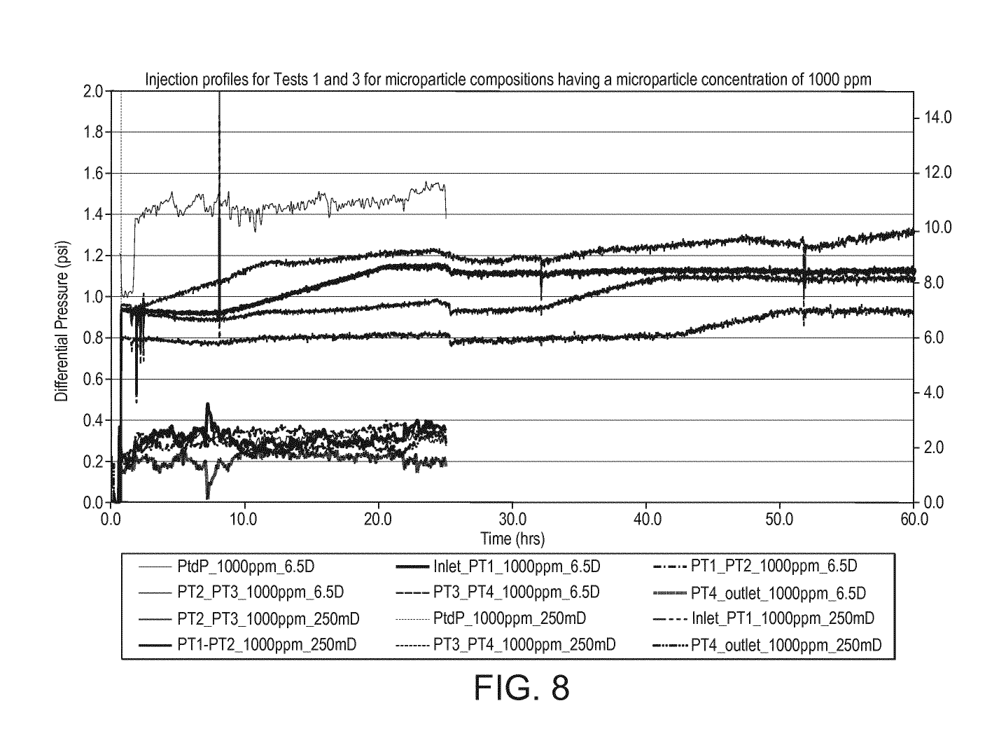

FIG. 8 shows injection profiles for Sandpack Tests 1 and 3 (for compositions with a microparticle concentration of 1000 ppm).

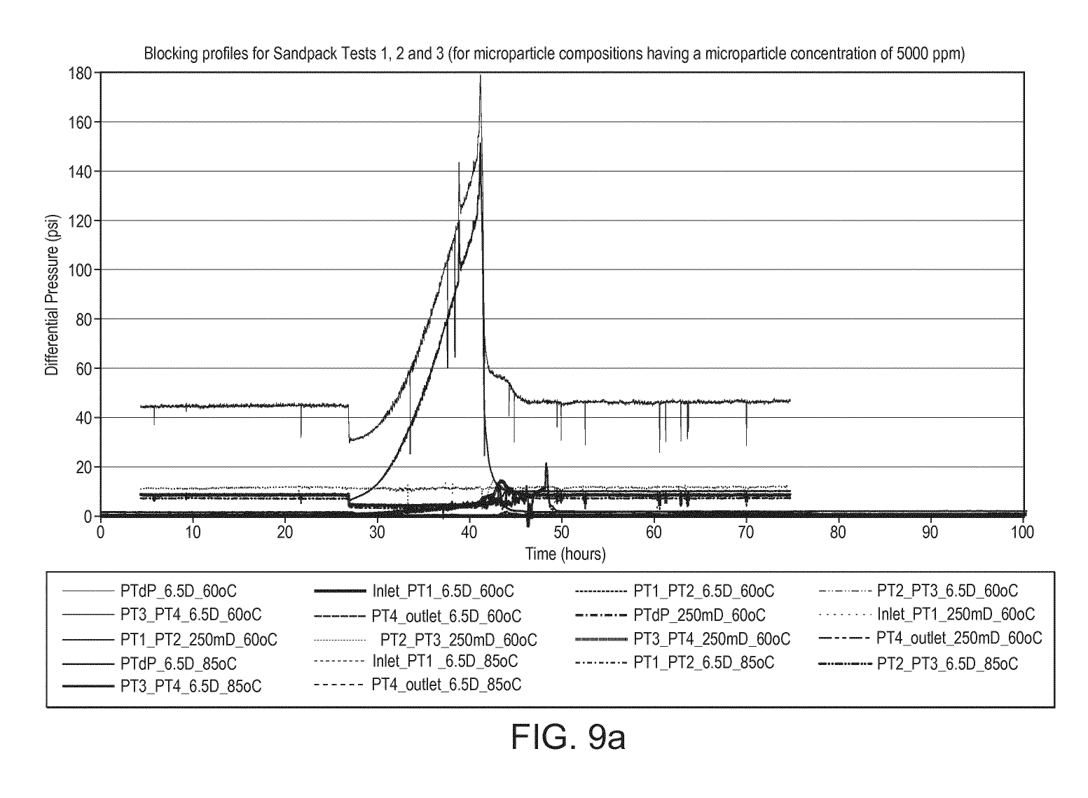

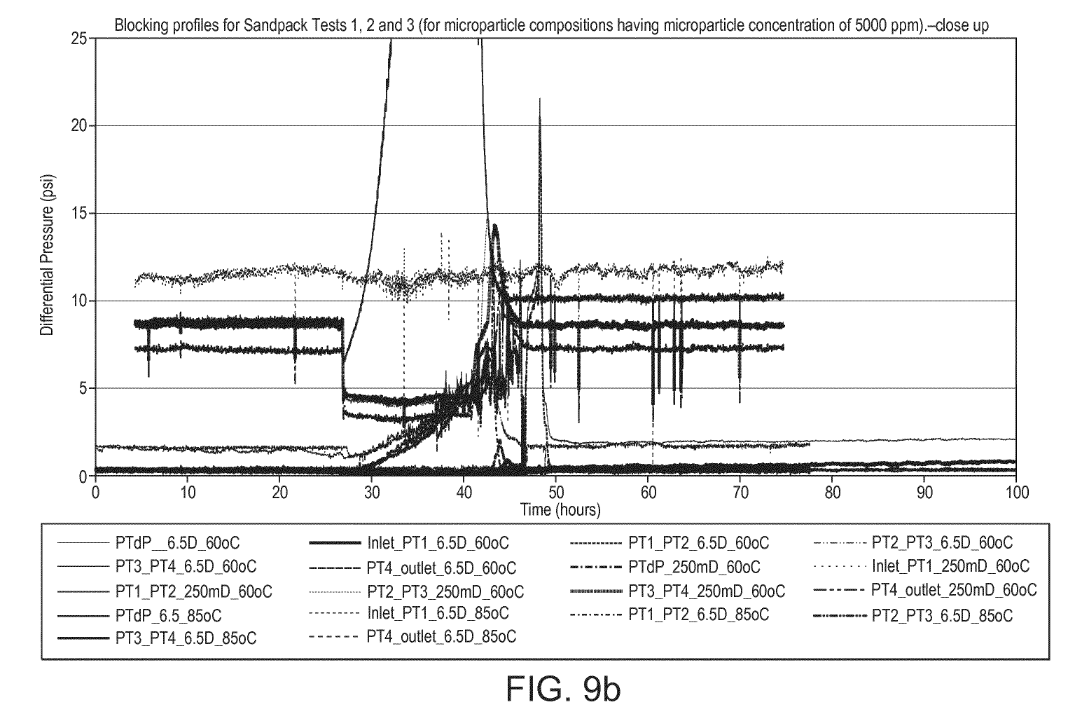

FIGS. 9a and 9b show blocking profiles for Sandpack Tests 1 to 3 (for compositions with a microparticle concentration of 5000 ppm).

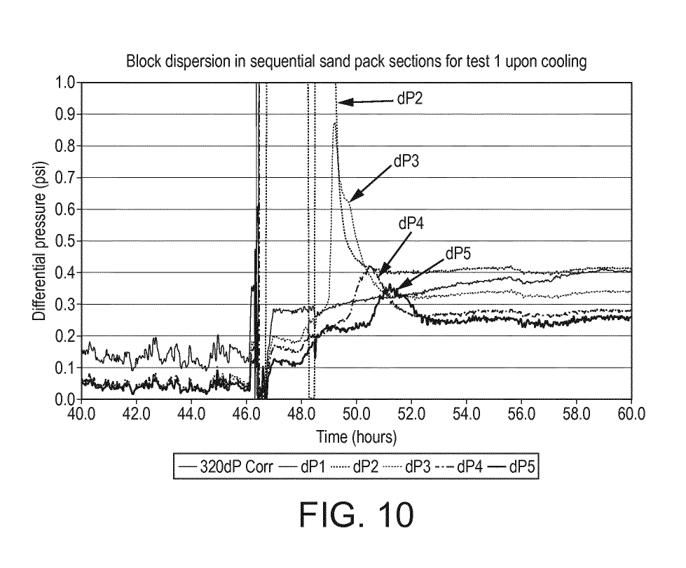

FIG. 10 shows dispersion of a block in sequential sandpack sections, upon cooling, for Sandpack Test 1.

### EXAMPLES

Unless otherwise stated, emulsion polymerization was used in the syntheses of the crosslinked polymeric microparticles.

### Direct Synthesis of Poly(N,N′-dimethyhmethacryloylethyl)ammonium propane sulfonate) (PDMAPS) Microparticles by Inverse Emulsion Polymerization

Polyoxyethylene sorbitan monooleate (Tween 80) surfactant (1.7 g, 2 wt. % based on the total weight of the emulsion), N,N′-dimethyl(methacryloylethyl)ammonium propane sulfonate (DMAPS) monomer (1.9 g), poly(ethylene glycol) dimethacrylate (PEGDMA) cross-linking monomer having a number average molecular weight (Mₙ) of 550 Da (0.1 g, 5 wt. % of the total weight of DMAPS and PEGDMA monomers) and radical initiator 4,4′-azobis(4-cyanovaleric acid) (ACVA) (0.02 g, 1 wt. % of the total weight of DMAPS and PEGDMA monomers) were dissolved by stirring in water (6 mL) having a resistivity of 18.2 MΩ·cm. Toluene (80 mL) was added to the resulting aqueous solution and the mixture was sonicated in an ice bath for 10 minutes. The resulting emulsion was purged with nitrogen for 30 minutes and then heated in an oil bath with stirring (750 rpm) at a temperature of 65° C. for 16 hours.

The resulting polymeric microparticles were found to be ill-defined with a broad size distribution as determined by dynamic light scattering (DLS) and scanning electron microscopy (SEM) analyses. The microparticle diameters were found to be in the range of 70 to 160 nm by SEM. These microparticles are not suitable for use in the method of the present invention.

### Direct Synthesis of Poly(N,N′-dimethyhmethacryloylethyl)ammonium propane sulfonate) (PDMAPS) Microparticles by Dispersion Polymerization

Polyoxyethylene sorbitan monooleate (Tween 80) surfactant (2 g, 2 wt. % based on the total weight of the dispersion), DMAPS monomer (5 g, 5 wt. % based on the total dispersion), N,N′-methylenebisacrylamide (MBAc) crosslinking monomer (0.025 g, 0.5 wt. % based on the weight of the DMAPS monomer) and the radical initiator 2,2′-azobis(2-methylpropionamidine)dihydrochloride (V-50) (0.04 g, 0.8 wt. % based on the weight of the DMAPS monomer) were dissolved in water (93 mL) having a resistivity of 18.2 MΩ·cm (in the order listed) by stirring. The mixture was purged with nitrogen for 30 minutes and then heated in an oil bath with stirring (600 rpm) at a temperature of 65° C. for 16 hours.

The resulting microparticles were found to be ill-defined with a broad size distribution as determined by dynamic light scattering (DLS) and scanning electron microscopy (SEM) analyses. The microparticle diameters were found to be in the range of 500 to 900 nm by SEM. These microparticles are not suitable for use in the method of the present invention.

### Synthesis of Stabilizers for Use in the Synthesis of Precursor Microparticles

Poly(N,N′-dimethyl(methacryloylethyl)ammonium propane sulfonate) (PDMAPS) polymeric stabilizers were prepared by reversible addition-fragmentation chain transfer (RAFT) polymerization according to the procedures described below.

The resulting PDMAPS polymeric stabilizers have a dithiobenzoate end group arising from the chain transfer agent (CTA) used in this synthetic procedure. It was found that retention of the dithiobenzoate end-group in the PDMAPS stabilizer allowed for covalent attachment of the stabilizer to the polymeric microparticles during polymerization.

### (a) Synthesis of Poly(N,N′-dimethyl(methacryloylethyl)ammonium propane sulfonate)(PDMAPS) Polymeric Stabilizer with Number Average Molecular Weight (MO of 5000 Daltons (Da)

N,N′-dimethyl(methacryloylethyl)ammonium propane sulfonate (DMAPS) monomer (5 g, 18 equivalents based on the amount of chain transfer agent), 4-cyano-4-(phenylcarbonothioylthio)pentanoic acid chain transfer agent (CTA) (1 equivalent) and 4,4′-azobis(4-cyanovaleric acid) (ACVA) radical initiator (0.2 equivalents based on the amount of CTA) were dissolved in 0.5 M aqueous solution of NaCl and the resulting solution was adjusted to a pH value of 7 by the addition of dilute aqueous NaOH. After transferring the solution to an ampoule provided with a stirrer bar, the solution was degassed by purging with nitrogen for 30 minutes while stirring. The polymerisation reaction was started by immersion of the ampoule in an oil bath heated to a temperature of 65° C. and the polymerization mixture was stirred at this temperature for 4 hours. The polymerization reaction was then stopped by cooling and exposing the polymerization mixture to air. The resulting polymer was purified by extensive dialysis against deionized water (1 kDa MWCO dialysis tubing) with at least 6 changes of water, and was recovered as a pink solid by freeze-drying. The resulting polymer had a number average molecular weight (Mₙ) of 5 kDa as determined by ¹H NMR spectroscopy.

### (b) Synthesis of Poly(N,N′-dimethyl(methacryloylethyl)ammonium propane sulfonate) (PDMAPS Polymeric Stabilizer with Number Average Molecular Weight (Mₙ) of 20,000 Daltons (Da)

N,N′-dimethyl(methacryloylethyl)ammonium propane sulfonate (DMAPS) monomer (5 g, 72 equivalents based on the amount of chain transfer agent), 4-cyano-4-(phenylcarbonothioylthio)pentanoic acid chain transfer agent (CTA) (1 equivalent) and 4,4′-azobis(4-cyanovaleric acid) (ACVA) radical initiator (0.2 equivalents based on the amount of CTA) were dissolved in a 0.5 M aqueous solution of NaCl and the resulting solution was adjusted to a pH value of 7 by the addition of dilute aqueous NaOH. After transferring the solution to an ampoule provided with a stirrer bar, the solution was degassed by purging with nitrogen for 30 minutes while stirring. The polymerisation reaction was started by immersion of the ampoule in an oil bath heated to a temperature of 65° C. and the polymerization mixture was stirred at this temperature for 4 hours. The polymerization reaction was then stopped by cooling and exposing the polymerization mixture to air. The resulting polymer was purified by extensive dialysis against deionized water (1 kDa MWCO dialysis tubing) with at least 6 changes of water, and was recovered as a pink solid by freeze-drying. The resulting polymeric stabilizer had a number average molecular weight (Mₙ) of 20 kDa as determined by ¹H NMR spectroscopy.

### Synthesis of Poly(2-(diethylamino)ethyl methacrylate) (PDEAEMA) Precursor Microparticles

A number of syntheses of poly(2-(diethylamino)ethyl methacrylate) (PDEAEMA) precursor microparticles were performed using different stabilizers.

### Synthesis of Poly(2-(diethylamino)ethyl methacrylate) (PDEAEMA) Precursor Microparticles using Sodium dodecyl sulfate (SDS) as a Surfactant Stabilizer

SDS surfactant (0.24 g, 20 wt. % based on the weight of the DEAEMA monomer), 2-(diethylamino)ethyl methacrylate (DEAEMA) monomer (1.2 g) and ethylene glycol dimethacrylate (EGDMA) cross-linking monomer (0.012 g, 1 wt. % based on the weight of DEAEMA monomer) were dispersed in water (38 mL) having a resistivity of 18.2 MΩ·cm by stirring (in the order listed). The mixture was purged with nitrogen for 30 minutes with stirring and then heated for 30 minutes in an oil bath at a temperature of 65° C. with stirring. The radical initiator potassium persulfate (KPS) (0.012 g, 1 wt. % of the DEAEMA monomer) was dissolved separately in water (1 mL) having a resistivity of 18.2 MΩ·cm and purged for 10 minutes with nitrogen. The degassed KPS solution was added to the degassed surfactant and monomer solution to initiate polymerization. The resulting polymerization mixture was heated in an oil bath with stirring (magnetic stirrer with oval shaped bar, 600 rpm) at 65° C. for 16 hours. The resulting well-defined microparticles were obtained as a dispersion in water. The hydrodynamic diameter (Dₕ) of the microparticles was determined by dynamic light scattering and found to be 60 nm with a dispersity of 0.19.

### Synthesis of Poly(2-(diethylamino)ethyl methacrylate) (PDEAEMA) Precursor Microparticles using Poly(ethylene glycol) methacrylate (Mₙ=360 Da) as a Polymeric Stabilizer

Poly(ethylene glycol) methacrylate (PEGMA) stabilizer (Mₙ=360 Da) (0.04 g, 1.6 wt. % based on the weight of the DEAEMA monomer), 2-(diethylamino)ethyl methacrylate (DEAEMA) monomer (2.5 g) and ethylene glycol dimethacrylate (EGDMA) cross-linking monomer (0.025 g, 1 wt. % based on the weight of DEAEMA monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % of the DEAEMA monomer) was dissolved separately in water (1 mL) having a resistivity of 18.2 MΩ·cm and the resulting solution was purged for 10 minutes with nitrogen. The degassed KPS solution was then added to the degassed surfactant and monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 190 nm with a dispersity of 0.03.

### Synthesis of Poly(2-(diethylamino)ethyl methacrylate) (PDEAEMA) Precursor Microparticles using Poly(ethylene glycol) methacrylate (Mₙ=950 Da) as a Polymeric Stabilizer

Poly(ethylene glycol) methacrylate (PEGMA) stabilizer (Mₙ=950 Da) (0.10 g, 4 wt. % based on the weight of DEAEMA monomer), 2-(diethylamino)ethyl methacrylate (DEAEMA) monomer (2.5 g) and ethylene glycol dimethacrylate (EGDMA) cross-linking monomer (0.025 g, 1 wt. % based in the weight of DEAEMA monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % based on the weight of DEAEMA monomer) was dissolved separately in water (1 mL) having a resistivity of 18.2 MΩ·cm and purged for 10 minutes with nitrogen. The degassed KPS solution was added to the degassed surfactant and monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 215 nm with a dispersity of 0.10.

### Synthesis of Poly(2-(diethylamino)ethyl methacrylate) (PDEAEMA) Precursor Microparticles using Poly(N,N′-dimethyl(methacryloylethyl)ammonium propane sulfonate) DMAPS (Mₙ=5000 Da) as Polymeric Stabilizer

Poly(N,N′-dimethyl(methacryloylethyl)ammonium propane sulfonate) (PDMAPS) stabilizer having a dithiobenzoate chain transfer agent (CTA) end-group (Mₙ=5000 Da) prepared according to the procedure described above (0.1 g, 4 wt. % based on the weight of DEAEMA monomer), 2-(diethylamino)ethyl methacrylate (DEAEMA) monomer (2.5 g) and ethylene glycol dimethacrylate (EGDMA) cross-linking monomer (0.025 g, 1 wt. % based on the weight of DEAEMA monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring.

The radical initiator potassium persulfate (KPS) (0.025 g, 1 wt. % based on the weight of DEAEMA monomer) was dissolved separately in water (1 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 110 nm with a dispersity of 0.07.

### Synthesis of Poly(2-(diethylamino)ethyl methacrylate) (PDEAEMA) Precursor Microparticles using Poly(N,N′-dimethyl(methacryloylethyl)ammonium propane sulfonate) (DMAPS) (Mₙ=20,000 Da) as a Polymeric Stabilizer

Poly(N,N′-dimethyl(methacryloylethyl)ammonium propane sulfonate) (PDMAPS) stabilizer (Mₙ=20,000 Da) prepared according to the procedure described above (0.1 g, 4 wt. % based on the weight of DEAEMA monomer), 2-(diethylamino)ethyl methacrylate monomer (DEAEMA) (2.5 g), and ethylene glycol dimethacrylate (EGDMA) cross-linking monomer (0.025 g, 1 wt. % based on the weight of DEAEMA monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % based on the weight of DEAEMA monomer) was dissolved separately in water (1 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 160 nm with a dispersity of 0.04.

### Variation of Cross-Linking Density of the Poly(2-(diethylamino)ethyl methacrylate) (PDEAEMA) Precursor Microparticles

A number of experiments were performed in which the cross-linking density of the PDEAEMA precursor microparticles was varied:

### (a) 0.5 wt. % Cross-Linker (EGDMA) with PEGMA Stabilizer

Poly(ethylene glycol) methacrylate (PEGMA) stabilizer (Mₙ=360 Da) (0.04 g, 1.6 wt. % based on the weight of DEAEMA), 2-(diethylamino)ethyl methacrylate (DEAEMA) monomer (2.5 g) and ethylene glycol dimethacrylate (EGDMA) cross-linking monomer (0.012 g, 0.5 wt. % based on the weight of DEAEMA) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % based on the weight of DEAEMA) was dissolved separately in water (1 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 470 nm with a dispersity of 0.16.

### (b) 5 wt. % Cross-Linker (EGDMA) with PEGMA Stabilizer

Poly(ethylene glycol) methacrylate (PEGMA) stabilizer (Mₙ=360 Da) (0.04 g, 1.6 wt. % based on the weight of DEAEMA), 2-(diethylamino)ethyl methacrylate (DEAEMA) monomer (2.5 g), and ethylene glycol dimethacrylate (EGDMA) cross-linking monomer (0.125 g, 5 wt. % based on the weight of DEAEMA) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % to DEAEMA) was dissolved separately in water (1 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 150 nm with a dispersity of 0.19.

### (c) 0.5 wt. % Cross-Linker (EGDMA) with PDMAPS Stabilizer

Poly(N,N′-dimethyl(methacryloylethyl)ammonium propane sulfonate) (PDMAPS) stabilizer (Mₙ=20,000 Da) having a dithiobenzoate chain transfer agent (CTA) end-group prepared according to the procedure described above (0.1 g, 4 wt. % based on the weight of DEAEMA), 2-(diethylamino)ethyl methacrylate (DEAEMA) monomer (2.5 g) and ethylene glycol dimethacrylate (EGDMA) cross-linking monomer (0.012 g, 0.5 wt. % based on the weight of DEAEMA) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % based on the weight of DEAEMA) was dissolved separately in water (1 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 130 nm with a dispersity of 0.40.

### (d) 5 wt. % Cross-Linker (EGDMA) with PDMAPS Stabilizer

Poly(N,N′-dimethyl(methacryloylethyl)ammonium propane sulfonate) (PDMAPS) stabilizer (Mₙ=20,000 Da) having a dithiobenzoate chain transfer agent (CTA) end-group prepared according to the procedure described above (0.1 g, 4 wt. % based on the weight of DEAEMA), 2-(diethylamino)ethyl methacrylate (DEAEMA) monomer (2.5 g) and ethylene glycol dimethacrylate (EGDMA) cross-linking monomer (0.125 g, 5 wt. % based on the weight of DEAEMA) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % based on the weight of DEAEMA) was dissolved separately in water (1 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 130 nm with a dispersity of 0.08.

### Synthesis of Precursor Microparticles Comprising Copolymers of 2-(diethylamino)ethyl methacrylate (DEAEMA) and benzyl methacrylate (BnMA)

Precursor microparticles comprising copolymers of 2-(diethylamino)ethyl methacrylate (DEAEMA) and benzyl methacrylate (BnMA) were prepared using different weight ratios of DEAEMA and BnMA.

### (a) 1:1 Weight Ratio of DEAEMA:BnMA

Poly(N,N′-dimethyl(methacryloylethyl)ammonium propane sulfonate) (PDMAPS) (Mₙ=5000 Da) having a dithiobenzoate chain transfer agent (CTA) end-group prepared according to the procedure described above (0.1 g, 4 wt. % based on the total weight of monomer), the monomers benzyl methacrylate (BnMA) (1.25 g) and 2-(diethylamino)ethyl methacrylate (DEAEMA) (1.25 g) and the cross-linking monomer ethylene glycol dimethacrylate (EGDMA) (0.025 g, 1 wt. % based on the total weight of monomer) were dispersed in water (44 mL) having a resistivity of 18.2 MΩ·cm by stirring (in the order listed). The mixture was purged with nitrogen for 30 minutes with stirring and then heated for 30 minutes in an oil bath at a temperature of 65° C. with stirring. The radical initiator potassium persulfate (KPS) (0.025 g, 1 wt. % based on the total weight of monomer) was dissolved separately in water (1 mL) having a resistivity of 18.2 MΩ·cm and purged for 10 minutes with nitrogen. The degassed KPS solution was added to the degassed surfactant and monomer solution to initiate polymerization. The mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 70 nm with a dispersity of 0.03.

### (b) 0.7:0.3 Weight Ratio of DEAEMA:BnMA

Poly(N,N′-dimethyl(methacryloylethyl)ammonium propane sulfonate) (PDMAPS) (Mₙ=5000 Da) having a dithiobenzoate chain transfer agent (CTA) end-group prepared according to the procedure described above (0.1 g, 4 wt. % based on the total weight of monomer), the monomers benzyl methacrylate (BnMA) (0.75 g) and 2-(diethylamino)ethyl methacrylate (DEAEMA) (1.75 g) and the cross-linking monomer ethylene glycol dimethacrylate (EGDMA) (0.025 g, 1 wt. % based on the total weight of monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % to overall monomer) was dissolved separately in water (1 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 75 nm with a dispersity of 0.05.

### Synthesis of Precursor Microparticles by Varying the Dialkylaminoalkyl (Alkyl)acrylate Monomer

A number of experiments were performed in which the dialkylaminoalkyl (alkyl)acrylate used in the preparation of the precursor microparticles was varied:

### Synthesis of Poly(2-(diisopropylamino)ethyl methacrylate) (PDPAEMA) Precursor Microparticles

A number of syntheses of poly 2-(diisopropylamino)ethyl methacrylate (PDPAEMA) precursor microparticles were prepared using different polymeric stabilizers.

### (a) Synthesis of Poly(2-(diisopropylamino)ethyl methacrylate) (PDPAEMA) Precursor Microparticles Using PEGMA (Mₙ=360 Da) as a Polymeric Stabilizer

Poly(ethylene glycol) methacrylate (PEGMA) stabilizer (Mₙ=360 Da) (0.08 g, 3.2 wt. % based on the weight of the DPAEMA monomer), 2-(diisopropylamino)ethyl methacrylate (DPAEMA) monomer (2.5 g) and ethylene glycol dimethacrylate (EGDMA) cross-linking monomer (0.025 g, 1 wt. % based on the weight of DPAEMA monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.025 g, 1 wt. % of the DPAEMA monomer) was dissolved separately in water (1 mL) having a resistivity of 18.2 MΩ·cm and the resulting solution was purged for 10 minutes with nitrogen. The degassed KPS solution was then added to the degassed surfactant and monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 360 nm with a dispersity of 0.03.

### (b) Synthesis of Poly(2-(diisopropylamino)ethyl methacrylate) (PDPAEMA) Precursor Microparticles Using PEGMA (Mₙ=2000 Da) as a Polymeric Stabilizer

PEGMA stabilizer (Mₙ=2000 Da) (0.20 g, 8 wt. % based on the weight of the DPAEMA monomer), DPAEMA monomer (2.5 g) and EGDMA cross-linking monomer (0.025 g, 1 wt. % based on the weight of DPAEMA monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator KPS (0.025 g, 1 wt. % of the DPAEMA monomer) was dissolved separately in water (1 mL) having a resistivity of 18.2 MΩ·cm and the resulting solution was purged for 10 minutes with nitrogen. The degassed KPS solution was then added to the degassed surfactant and monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 260 nm with a dispersity of 0.06.

### (c) Synthesis of Poly(2-(diisopropylamino)ethyl methacrylate) (PDPAEMA) Precursor Microparticles Using PDMAPS (Mₙ=5000 Da) as Polymeric Stabilizer

Poly(N,N′-dimethyl(methacryloylethyl)ammonium propane sulfonate) (PDMAPS) stabilizer having a dithiobenzoate chain transfer agent (CTA) end-group (Mₙ=5000 Da) prepared using the procedure described above (0.1 g, 4 wt. % based on the weight of DPAEMA monomer), 2-(diisopropylamino)ethyl methacrylate (DPAEMA) monomer (2.5 g) and EGDMA cross-linking monomer (0.025 g, 1 wt. % based on the weight of DPAEMA monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator KPS (0.025 g, 1 wt. % of the DPAEMA monomer) was dissolved separately in water (1 mL) having a resistivity of 18.2 MΩ·cm and the resulting solution was purged for 10 minutes with nitrogen. The degassed KPS solution was then added to the degassed surfactant and monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 130 nm with a dispersity of 0.01.

### Synthesis of Poly(2-(dimethylamino)ethyl methacrylate) (DMAEMA) Precursor Microparticles

SDS surfactant (0.24 g, 20 wt. % based on the weight of DMAEMA), 2-(dimethylamino)ethyl methacrylate (DMAEMA) monomer (1.2 g) and ethylene glycol dimethacrylate (EGDMA) cross-linking monomer (0.012 g, 1 wt. % based on the weight of DMAEMA) were dispersed in water (38 mL) having a resistivity of 18.2 MΩ·cm (with the pH adjusted to a value of 9 to ensure the DMAEMA was deprotonated and water insoluble) by stirring (in the order listed). The resulting mixture was purged with nitrogen for 30 minutes with stirring and then heated for 30 minutes in an oil bath at a temperature of 65° C. with stirring. The radical initiator potassium persulfate (KPS) (0.012 g, 1 wt. % based on the weight of DMAEMA) was dispersed separately in water (1 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting particles were obtained as a dispersion in water. DLS analysis revealed the particles were ill-defined with a size range of Dₕ=10-20 nm.

### Synthesis of Poly(3-(dimethylamino)propyl methacrylamide) (PDMAPMA) Precursor Microparticles Using sodium dodecyl sulfate (SDS) as a Surfactant Stabilizer by Dispersion Polymerization

SDS surfactant (0.10 g, 20 wt. % based on the weight of the DMAPMA monomer), 3-(dimethylamino)propyl methacrylamide (DMAPMA) monomer (0.5 g) and N,N′-methylenebisacrylamide (MBAc) cross-linking monomer (0.005 g, 1 wt. % based on the weight of DMAPMA monomer) were dispersed in water (49 mL) having a resistivity of 18.2 MΩ·cm by stirring (in the order listed). The mixture was purged with nitrogen for 30 minutes with stirring and then heated for 30 minutes in an oil bath at a temperature of 65° C. with stirring. The radical initiator potassium persulfate (KPS) (0.005 g, 1 wt. % of the DMAPMA monomer) was dissolved separately in water (1 mL) having a resistivity of 18.2 MΩ·cm and purged for 10 minutes with nitrogen. The degassed KPS solution was added to the degassed surfactant and monomer solution to initiate polymerization. The resulting polymerization mixture was heated in an oil bath with stirring (magnetic stirrer with oval shaped bar, 600 rpm) at 65° C. for 16 hours. The resulting well-defined microparticles were obtained as a dispersion in water. The hydrodynamic diameter (Dₕ) of the microparticles was determined by dynamic light scattering and found to be 11 nm with a dispersity of 0.26.

### Synthesis of Poly(N-(4-vinylbenzyl)-N,N-dimethylamine) (PVBDMA) Precursor Microparticles

N-(4-Vinylbenzyl)-N,N-dimethylamine (VBDMA) was selected as an example of a vinylbenzyldialkylamine monomer. This example also demonstrates variation of the cross-linking monomer with use of a styrenic cross-linker divinylbenzene (DVB).

### Synthesis of Poly(N-(4-vinylbenzyl)-N,N-dimethylamine) (PVBDMA) Precursor Microparticles Using Sodium Dodecylsulfate (SDS) as a Surfactant Stabilizer

SDS surfactant (0.10 g, 20 wt. % based on the weight of the VBDMA monomer), N-(4-vinylbenzyl)-N,N-dimethylamine (VBDMA) monomer (0.5 g) and divinylbenzene (DVB) cross-linking monomer (0.005 g, 1 wt. % based on the weight of VBDMA monomer) were dispersed in water (49 mL) having a resistivity of 18.2 MΩ·cm by stirring (in the order listed). The mixture was purged with nitrogen for 30 minutes with stirring and then heated for 30 minutes in an oil bath at a temperature of 65° C. with stirring. The radical initiator potassium persulfate (KPS) (0.005 g, 1 wt. % of the VBDMA monomer) was dissolved separately in water (1 mL) having a resistivity of 18.2 MΩ·cm and purged for 10 minutes with nitrogen. The degassed KPS solution was added to the degassed surfactant and monomer solution to initiate polymerization. The resulting polymerization mixture was heated in an oil bath with stirring (magnetic stirrer with oval shaped bar, 600 rpm) at 65° C. for 16 hours. The resulting well-defined microparticles were obtained as a dispersion in water. The hydrodynamic diameter (Dₕ) of the microparticles was determined by dynamic light scattering and found to be 48 nm with a dispersity of 0.08.

### Synthesis of Poly(N-(4-vinylbenzyl)-N,N-dimethylamine) (PVBDMA) Precursor Microparticles Using PEGMA (Mₙ=2000 Da) as a Polymeric Stabilizer

PEGMA stabilizer (Mₙ=2000 Da) (0.13 g, 7.6 wt. % based on the weight of the VBDMA monomer), VBDMA monomer (2.5 g) and divinylbenzene (DVB) cross-linking monomer (0.025 g, 1 wt. % based on the weight of VBDMA monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator KPS (0.025 g, 1 wt. % of the VBDMA monomer) was dissolved separately in water (1 mL) having a resistivity of 18.2 MΩ·cm and the resulting solution was purged for 10 minutes with nitrogen. The degassed KPS solution was then added to the degassed surfactant and monomer solution to initiate polymerization. The resulting polymerization mixture was heated in an oil bath with stirring (magnetic stirrer with oval shaped bar, 600 rpm) at a temperature of 65° C. for 16 hours. The resulting microparticles were obtained as a dispersion in water, however a large amount of particle aggregation was observed. The hydrodynamic diameter (Dₕ) of the microparticles was determined by dynamic light scattering and found to be 250 nm with a dispersity of 0.29.

### Synthesis of Polyvinyl-N-heterocyclic amine Precursor Microparticles

Poly(4-Vinylpyridine) (P4VP) was selected as an example of a vinyl-N-heterocyclic amine monomer.

### Synthesis of Poly(4-vinylpyridine) (P4VP) Precursor Microparticles by Emulsion Polymerization Using PDMAPS (Mₙ=5000 Da) as Polymeric Stabilizer

Poly(N,N′-dimethyl(methacryloylethyl)ammonium propane sulfonate) (PDMAPS) stabilizer having a dithiobenzoate chain transfer agent (CTA) end-group (Mₙ=5000 Da) prepared according to the procedure described above (0.1 g, 4 wt. % based on the weight of 4-VP monomer), 4-vinylpyridine (4-VP) monomer (2.5 g) and divinylbenzene (DVB) cross-linking monomer (0.025 g, 1 wt. % based on the weight of 4-VP monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator KPS (0.025 g, 1 wt. % of the 4-VP monomer) was dissolved separately in water (1 mL) having a resistivity of 18.2 MΩ·cm and the resulting solution was purged for 10 minutes with nitrogen. The degassed KPS solution was then added to the degassed surfactant and monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 150 nm with a dispersity of 0.07.

### Synthesis of Poly(4-vinylpyridine) (P4VP) Precursor Microparticles using Surfactant Free Emulsion Polymerization

4-Vinylpyridine (4-VP) monomer (1 g) and divinylbenzene (DVB) cross-linking monomer (0.005 g, 0.5 wt. % based on the weight of 4-VP monomer) were dispersed in water (44 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring. The radical initiator KPS (0.01 g, 1 wt. % of the 4-VP monomer) was dissolved separately in water (1 mL) having a resistivity of 18.2 MΩ·cm and the resulting solution was purged for 10 minutes with nitrogen. The degassed KPS solution was then added to the degassed surfactant and monomer solution to initiate polymerization. The resulting polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 200 nm with a dispersity of 0.04.

### Betainisation Reactions

### Sulfobetainisation of PDEAEMA Precursor Microparticles

### (a) Use of Propane Sultone as Sulfobetainisation Reagent

HPLC grade tetrahydrofuran (THF)(4 mL) was added dropwise to a dispersion of PDEAEMA precursor microparticles having a PEGMA shell (PEGMA Mₙ=360 Da) dispersed in water (4 mL) having a resistivity of 18.2 MΩ·cm (particle concentration=50 mg/mL) with stirring. 1,3-propane sultone (0.069 g, 0.5 molar equivalents based on the structural units derived from DEAEMA in the precursor microparticles) was added and the solution stirred for 16 hours at a temperature of 60° C. Trimethylamine (0.3 mL of a 1M solution in THF, 1 molar equivalent based on the molar amount of 1,3-propane sultone) was added (to react with any unreacted 1,3-propane sultone) and the dispersion stirred for a further 16 hours. The betainised microparticles were purified by extensive dialysis against deionised water (using dialysis tubing having a 1-14 kDa molecular weight cut-off (MWCO)) with at least 6 changes of water.

In an alternative synthetic method, HPLC grade THF (25 mL) was added to freeze-dried PDEAEMA particles (0.5 g) to give a concentration of precursor microparticles of 20 mg/mL and the mixture was sonicated to disperse the precursor microparticles. 1,3-propane sultone (0.16 g, 0.5 molar equivalents based on the structural units derived from DEAEMA repeat in the precursor microparticles) was added and the dispersion stirred for 16 hours at a temperature of 60° C. Trimethylamine (0.3 mL of a 1M solution in THF, 1 molar equivalent based on the molar amount of 1,3-propane sultone) was added (to react with any unreacted 1,3-propane sultone) and the dispersion stirred for a further 16 hours. The sulfobetainised microparticles were purified by extensive dialysis against deionised water (using dialysis tubing having a 12-14 kDa molecular weight cut-off (MWCO)) with at least 6 changes of water. The resulting well-defined microparticles were obtained as a dispersion in water. The hydrodynamic diameter (Dₕ) of the microparticles was determined by dynamic light scattering and found to be 150 nm with a dispersity of 0.03.

### (b) Use of Sodium 3-Bromopropane Sulfonate as Sulfobetainisation Reagent

Propan-2-ol (300 mL), sodium 3-bromopropane sulfonate (6.0 g, 0.33 molar equivalents based on the structural units derived from DEAEMA in the precursor microparticles) and NaOH (20 mL of 0.2M aqueous solution, 0.05 molar equivalents based on the structural units derived from DEAEMA in the precursor microparticles) were added portion-wise to a dispersion of PDEAEMA particles in water (300 mL) having a resistivity of 18.2 MΩ·cm (precursor microparticle concentration=50 mg/mL). The dispersion was heated to a temperature of 75° C. and stirred for 40 hours. Unreacted sodium 3-bromopropane sulfonate reactant, propan-2-ol solvent and NaBr by-product were removed via extensive dialysis against deionised water (using dialysis tubing having a 12-14 kDa MWCO) with at least 6 changes of water. The resulting well-defined sulfobetainised microparticles were obtained as a dispersion in water. The hydrodynamic diameter (Dₕ) of the microparticles was determined by dynamic light scattering and found to be 100 nm with a dispersity of 0.05.

The above procedure was modified by using 0.25. 0.5, 0.75 and 3 molar equivalents of the betainisation reagent sodium 3-bromopropane sulfonate (based on the structural units derived from DEAEMA in the precursor microparticles) to target 25%, 50%, 75% and 100% betainisation respectively of the precursor microparticles. The resulting well-defined sulfobetainised microparticles were obtained as dispersions in water. The hydrodynamic diameter (Dₕ) of the 25%, 50%, 75% and 100% betainised microparticles were determined to be 100, 110, 110 and 190 nm respectively by DLS.

### (c) Use of Sodium 4-bromobutane sulfonate as Sulfobetainisation Reagent

Propan-2-ol (300 mL), sodium 4-bromobutane sulfonate (6.5 g, 0.33 molar equivalents based on the structural units derived from DEAEMA in the precursor microparticles) and NaOH (20 mL of 0.2M aqueous solution, 0.05 molar equivalents based on the structural units derived from DEAEMA in the precursor microparticles) were added portion-wise to a dispersion of PDEAEMA particles in water (300 mL) having a resistivity of 18.2 MΩ·cm (precursor microparticle concentration=50 mg/mL). The dispersion was heated to a temperature of 75° C. and stirred at this temperature for 40 hours. Unreacted sodium 4-bromobutane sulfonate, propan-2-ol solvent and NaBr by-product were removed via extensive dialysis against deionised water (using dialysis tubing having a 14 kDa MWCO) with at least 6 changes of water. The resulting well-defined sulfobetainised microparticles were obtained as a dispersion in water. The hydrodynamic diameter (Dₕ) of the microparticles was determined by dynamic light scattering and found to be 120 nm with a dispersity of 0.08.

### (d) Use of Sodium 2-Bromo-1-Ethane Sulfonate as Sulfobetainisation Reagent

Propan-2-ol (3 mL), sodium 2-bromo-1-ethane sulfonate (0.043 g, 0.25 molar equivalents based on the structural units derived from DEAEMA in the precursor microparticles) and NaOH (0.80 mL of 0.2M aqueous solution, 0.05 molar equivalents based on the structural units derived from DEAEMA in the precursor microparticles) were added portion-wise to a dispersion of PDEAEMA particles with a PDMAPS shell (Mₙ=5000 Da) dispersed in water (3 mL) having a resistivity of 18.2 MΩ·cm (precursor microparticle concentration=50 mg/mL). The dispersion was heated to a temperature of 75° C. and stirred for 40 hours. Unreacted sodium 2-bromo-1-ethane sulfonate, propan-2-ol solvent and NaBr by-product were removed via extensive dialysis against deionized water (using dialysis tubing having a 14 kDa MWCO) with at least 6 changes of water. The resulting sulfobetainised microparticles were found to aggregate and precipitate in both ultrapure water (resistivity of 18.2 MΩ·cm) and 0.3M NaCl.

### (e) Use of Sodium 3-chloro-2-hydroxy-1-propane sulfonate as Sulfobetainisation Reagent

Propan-2-ol (3 mL), sodium 3-chloro-2-hydroxy-1-propane sulfonate (0.055 g, 0.33 molar equivalents based on the structural units derived from DEAEMA in the precursor microparticles) and NaOH (0.80 mL of 0.2M aqueous solution, 0.05 molar equivalents based on the structural units derived from DEAEMA in the precursor microparticles) were added portion-wise to a dispersion of PDEAEMA particles with a PDMAPS shell (Mₙ=5000 Da) dispersed in water (3 mL) having a resistivity of 18.2 MΩ·cm (precursor microparticle concentration=50 mg/mL). The dispersion was heated to a temperature of 75° C. and stirred for 40 hours. Unreacted sodium 3-chloro-2-hydroxy-1-propane sulfonate, propan-2-ol solvent and NaCl by-product were removed via extensive dialysis against deionized water (using dialysis tubing having a 14 kDa MWCO) with at least 6 changes of water. The resulting well-defined sulfobetainised microparticles were obtained as a dispersion in water. The microparticles were found to have a betainisation level of ca. 30%.

The hydrodynamic diameter (Dₕ) of the microparticles was determined by dynamic light scattering and found to be 96 nm with a dispersity of 0.28. Variable temperature dynamic light scattering (DLS) experiments were performed to determine how the size (Dₕ) of the hydroxysulfobetained microparticles varied with temperature when dispersed in ultra-pure water having a resistivity of 18.2 MΩ·cm water. The results are shown in FIG. 6b

### Sulfabetainisation of PDEAEMA Precursor Microparticles

### Use of 1,3,2-Dioxathiane 2,2-dioxide as a Sulfabetainisation Reagent

Tetrahydrofuran (THF) (3 mL) was added dropwise to a dispersion of PDEAEMA precursor microparticles with a PDMAPS shell (Mₙ=5000 Da) dispersed in water having a resistivity of 18.2 MΩ·cm (3 mL, particle concentration=50 mg/mL) with stirring. 1,3,2-Dioxathiane 2,2-dioxide (0.056 g, 0.5 molar equivalents based on the structural units derived from DEAEMA in the precursor microparticles) was added and the solution stirred for 16 hours at a temperature of 65° C. The resulting sulfabetainised microparticles were purified by extensive dialysis against deionized water (using dialysis tubing having a 12-14 kDa molecular weight cut-off (MWCO)) with at least 6 changes of water. The resulting well-defined microparticles were obtained as a dispersion in water. The hydrodynamic diameter (Dₕ) of the microparticles was determined by dynamic light scattering and found to be 240 nm with a dispersity of 0.02.

### Carboxybetainisation of PDEAEMA Precursor Microparticles

Propan-2-ol (3 mL), sodium iodoacetate (0.084 g, 0.50 molar equivalents based on the structural units derived from DEAEMA in the precursor microparticles) and NaOH (0.80 mL of 0.2M aqueous solution, 0.05 molar equivalents based on the structural units derived from DEAEMA in the precursor microparticles) were added portion-wise to a dispersion of PDEAEMA particles with a PDMAPS shell (Mₙ=5000 Da) dispersed in water (3 mL) having a resistivity of 18.2 MΩ·cm (precursor microparticle concentration=50 mg/mL). The dispersion was stirred at room temperature for 24 hours. Unreacted sodium iodoacetate, propan-2-ol solvent and NaI by-product were removed via extensive dialysis against deionized water (using dialysis tubing having a 14 kDa MWCO) with at least 6 changes of water. The resulting well-defined carboxybetainised microparticles were obtained as a dispersion in water.

The hydrodynamic diameter (Dₕ) of the microparticles was determined by dynamic light scattering and found to be 140 nm with a dispersity of 0.02. Variable temperature dynamic light scattering (DLS) experiments were performed to determine how the size (Dₕ) of the carboxybetainised microparticles varied with temperature when dispersed in deionised water. The results are shown in FIG. 6c

### Dynamic Light Scattering Temperature Experiments

Dynamic light scattering (DLS) experiments were performed to determine how polysulfobetaine particle size (Dₕ) varied with temperature. DLS experiments were performed using a Malvern Zetasizer NanoS instrument with a 4 mW He—Ne 633 nm laser module and the data was analyzed using Malvern DTS v7.3.0 software. Polysulfobetainised microparticle dispersions were analyzed at a concentration of 1 mg/mL (in a quartz cuvette). Data was collected a temperature intervals of 5° C. over a temperature range (for example, over a temperature range of 5° C. to 90° C.) and the microparticle dispersion was allowed to equilibrate for at least five minutes at each temperature. At least 3 measurements were made at each temperature and data was reported as an average of these measurements.

FIG. 3 shows how the hydrodynamic diameter (Dₕ) of polysulfobetaine microparticles change with temperature when dispersed in ultra-pure water having a resistivity of 18.2 MΩ·cm water. The results presented in FIG. 3 are for microparticles with 50%, 75% and 100% levels of sulfobetainisation.

FIG. 4 shows how polysulfobetained microparticle hydrodynamic diameter (Dₕ) changes with temperature for microparticles dispersed in a 0.3M solution of sodium chloride. The microparticles have a 50% level of betainisation and either a n-propyl or n-butyl group linking the ammonium and sulfonate groups of the betaine moiety.

To test the reversibility of microparticle expansion and aggregation by DLS, the polysulfobetaine dispersions were cycled between two temperatures, one below the transition temperature and one above the transition temperature, for example, 35 and 70° C. respectively for a transition temperature of 50° C. The microparticles were heated at the higher temperature for 10 minutes per cycle and then allowed to cool to the lower temperature for up to 3 hours per cycle. FIG. 5 shows the reversible microparticle expansion and aggregation of polysulfobetaine microparticles in a 0.3M solution of NaCl (wherein the microparticles have a target betainisation level of 50%) where the microparticles were subjected to three heating and cooling cycles and microparticle size (hydrodynamic diameter, Dₕ) was determined by dynamic light scattering at temperatures of 35 and 70° C. during these heating and cooling cycles.

### Scaled-Up Synthesis of PDEAEMA Precursor Microparticles and Betainisation of the Precursor Microparticles

To prepare larger volumes of polysulfobetaine microparticle dispersions, the emulsion polymerization of DEAEMA was performed on a larger scale using 10 g DEAEMA monomer, compared with previous examples using 2.5 g of DEAEMA monomer.

### Precursor Microparticle Synthesis (10 g Scale)

PDEAEMA precursor microparticles were prepared at an increased scale (×4 original scale) using 10 g of DEAEMA as follows:

Poly(N,N′-dimethyl(methacryloylethyl)ammonium propane sulfonate) (PDMAPS) stabilizer having a dithiobenzoate chain transfer agent (CTA) end-group (Mₙ=5000 Da) (0.40 g, 4 wt. % based on the weight of DEAEMA monomer), 2-(diethylamino)ethyl methacrylate (DEAEMA) monomer (10 g) and ethylene glycol dimethacrylate (EGDMA) cross-linking monomer (0.10 g, 1 wt. % based on the weight of DEAEMA monomer) were dispersed in water (176 mL) having a resistivity of 18.2 MΩ·cm by stirring (in the order listed). The resulting mixture was purged with nitrogen for 30 minutes with stirring and then heated for 30 minutes in an oil bath at a temperature of 65° C. with stirring.

The radical initiator potassium persulfate (KPS) (0.10 g, 1 wt. % based on the weight of DEAEMA monomer) was dissolved separately in water (4 mL) having a resistivity of 18.2 MΩ·cm and purged for 10 minutes with nitrogen. The degassed KPS solution was added to the degassed surfactant and monomer solution to initiate polymerization. The polymerization mixture was heated in an oil bath with stirring (magnetic stirrer with oval shaped bar, 600 rpm) at a temperature of 65° C. for 16 hours. The resulting well-defined microparticles were obtained as a dispersion in water. The hydrodynamic diameter (Dₕ) of the microparticles was determined by dynamic light scattering and found to be 105 nm with a dispersity of 0.04.

### Sulfobetainisation of the Precursor Microparticles

The resulting PDEAEMA microparticles were betainised using the procedure given in Example 5(a). The resulting well-defined polysulfobetaine microparticles were obtained as a dispersion in water. The hydrodynamic diameter (Dₕ) of the microparticles was determined by dynamic light scattering and found to be 120 nm with a dispersity of 0.07.

FIG. 6 shows the DLS analytical data at a temperature of 25° C. for polysulfobetaine microparticles synthesised using the 2.5 g, and 10 g procedures.

### Sandpack Experiments

Sandpack tests were performed using a pack of a granular material (often referred to in the art as “sand”) located in a cylindrical tubing (often referred to in the art as a “column”) designed to simulate reservoir rock.

The sandpack comprised a 6.95 mm internal diameter, 9.53 mm external diameter column having a length of approximately 5 feet (152 cm) containing a dry sand. The column had four equally spaced pressure taps arranged along its length as shown in FIGS. 7a and 7b. The sandpack was provided with trace heating for heating the sandpack. Sections of the sandpack between adjacent pressure taps may be heated to different temperatures using the trace heating (as shown in FIGS. 7a and 7b). The compositions of the sands used for the sandpack tests are given below in Table 1 and the particle size distributions (screen analyses) in Tables 2 and 3. Sand A (RH110 DRY sand supplied by SIBELCO UK Ltd) was used for high permeability tests and Sand B (a sand supplied by AGSCO Corporation) was used for low permeability tests. The sands were retained in the column by means of: a 316L stainless steel mesh (25 μm, 500 mesh size) arranged at each of the pressure taps; a 316L stainless steel mesh (100 μm, 140 mesh size) arranged at the inlet of the column; and, a 316L stainless steel mesh (25 μm, 500 mesh size) arranged at the outlet of the column.

TABLE 1
Compositions of Sands A and B

| | | Sand B |
|---|---|---|
| | Sand A | Typical Amount |
| Mineral | Typical Amount (weight %) | (weight %) |
| SiO₂ | 99.38 | 99.5 |
| Fe₂O₃ | 0.091 | 0.05 |
| Al₂O₃ | 0.18 | 0.02 |
| TiO₂ | 0.15 | 0.005 |
| K₂O | 0.02 | — |
| Na₂O | <0.05 | 0.05 |
| ZrO₂ | — | 0.01 |
| MgO | — | 0.002 |
| CaO | — | 0.01 |
| SrO | — | 0.002 |
| Cr | — | <0.002 |
| P | — | <0.01 |
| CO₃²⁻ | — | <0.01 |
| Loss on ignition | 0.12 | 0.1 |

TABLE 2
Typical Particle size distribution of Sand A:

| | | Cumulative | | |
|---|---|---|---|---|
| | Cumulative | Amount of | Amount of | |
| Sieve | Amount of | Sand A | Sand A | |
| Mesh | Sand A Passing | Retained by | Retained by | Retained |
| Size | through Sieve | Sieve (weight | Each Sieve | Sand A |
| (microns) | (weight %) | %) | (weight %) | (weight %) |
| 1000 | 100.0 | 0.0 | 0.0 | 0.0 |
| 710 | 100.0 | 0.0 | 0.0 | 0.1 |
| 500 | 99.9 | 0.1 | 0.1 | |
| 355 | 99.8 | 0.2 | 0.1 | 1.0 |
| 250 | 98.9 | 1.1 | 0.9 | |
| 180 | 83.2 | 16.8 | 15.7 | 65.2 |
| 125 | 33.7 | 66.3 | 49.5 | |
| 90 | 9.1 | 90.0 | 24.6 | 32.6 |
| 63 | 1.1 | 98.9 | 8.0 | |
| <63 | | 100.0 | 1.1 | 1.1 |

TABLE 3
Typical Screen Analysis (Percent Retained) Sand B:

| US Sieve | #4 | #3 | #2 | #1 | #1/2 | #2/0 | #3/0 | #4/0 |
|---|---|---|---|---|---|---|---|---|
| 12 | 11.0 | | | | | | | |
| 14 | 25.4 | | | | | | | |
| 16 | 26.0 | | | | | | | |
| 18 | 21.3 | | | | | | | |
| 20 | 11.9 | 25.3 | | | | | | |
| 25 | 4.3 | 31.7 | | | | | | |
| 30 | 0.1 | 25.6 | 3.6 | | | | | |
| 35 | | 10.6 | 13.4 | | | | | |
| 40 | | 4.2 | 25.8 | | | | | |
| 50 | | 2.6 | 41.6 | 1.6 | | | | |
| 60 | | | 10.3 | 33.5 | 1.5 | | | |
| 70 | | | 4.3 | 38.7 | 13.5 | | | |
| 80 | | | 1.0 | 18.4 | 22.2 | | | |
| 100 | | | | 4.4 | 18.1 | 1.9 | | |
| 120 | | | | 1.0 | 18.8 | 21.0 | | |
| 140 | | | | 0.4 | 15.4 | 36.5 | 6.5 | 0.6 |
| 170 | | | | | 7.5 | 21.1 | 19.5 | 1.0 |
| 200 | | | | | 2.6 | 9.8 | 19.9 | 1.9 |
| 230 | | | | | 0.4 | 5.5 | 21.0 | 1.4 |
| 270 | | | | | | 2.8 | 18.3 | 2.0 |
| 325 | | | | | | 0.9 | 5.0 | 8.3 |
| Pan | Trace | Trace | Trace | Trace | Trace | 0.5 | 9.8 | 83.9 |
| | 100.0 | 100.0 | 100.0 | 100.0 | 100.0 | 100.0 | 100.0 | 100.0 |

### Sandpack Test Methodology

The sandpack containing either Sand A or Sand B was saturated with a test brine (0.3M solution of NaCl), delivered by a high pressure liquid chromatography (HPLC) pump, at a constant flow rate of 1.0 ml/min for a minimum of 16 hours, until stable differential pressures were obtained across the entire sandpack and across each individual section of the sandpack (i.e. the sections of the sandpack located between adjacent pressure taps). During this time, the sandpack and test fluids were maintained at an ambient temperature of between 18 and 21° C. The permeability of the entire sandpack and of each individual section of the sandpack to the test brine was determined at flow rates of 0.025, 0.05, 0.1, 0.2 and 0.4 ml/min and at ambient temperature.

The sandpack was then heated to a test temperature (approximately 5° C. greater than the maximum transition temperature of the betainised crosslinked polymeric microparticles of the test composition, which temperature was reached within 1 hour) and baseline differential pressures for the test brine at a flow rate of 0.1 ml/min were obtained across the whole sandpack and across each individual section of sandpack.

The sandpack was then cooled to ambient temperature. Once at ambient temperature, the test brine was reinjected into the sandpack at a flow rate of 0.1 ml/min until stable differential pressures were achieved across the entire sandpack and each individual section of the sandpack.

The test composition comprising a dispersion of the sulfobetainised crosslinked polymeric microparticles (1000, 2500 or 5000 ppm wt/vol) in an aqueous fluid (0.3 M solution of sodium chloride) was then injected at a flow rate of 0.1 ml/min until the sandpack was saturated with the composition (typically, after 40 to 48 hours). This saturation point was determined by visual comparison of the sandpack effluent with the pre-injected composition as well as from the stability of the differential pressures obtained across the entire sandpack and across the individual sections of the sandpack. Having saturated the sandpack with the test composition, the temperature of the sandpack was increased to the test temperature until a ‘block’ of expanded microparticles was formed (typically, 12 to 24 hours) as evidenced by an increase in differential pressure across one or more sections of the sandpack (where the block has formed) that is equal to, or in excess of, a resistance factor (RF) of 20, i.e.,

$$RF = \frac{{λ}_{w}}{{λ}_{p}} \geq 20$$

and λ_{w} and λₚ are the mobilities of the test brine and of the test composition. Once an RF>20 had been formed in one or more sections of the sandpack, the sandpack was cooled back to ambient temperature (over typically 2 to 3 hours) whilst continuing to inject the test composition at a constant flow rate of 0.1 ml/min until the ‘block’ had dissipated (dispersed) and/or had been flushed from the sandpack.

The test brine was then re-injected at a flow rate of 0.1 ml/min and at ambient temperature until any remaining test composition was flushed from the sandpack. The permeability of the sandpack and of each individual section of the sandpack was again determined by injecting the test brine at flow rates of 0.025, 0.05, 0.1, 0.2 and 0.4 ml/min and at ambient temperature.

The difference between the initial and final permeabilities of the sandpack, measured as residual resistance factor (RRF), was then taken as an indication of the reversibility of the formed ‘block’:

$$RRF = \frac{{λ}_{w}}{{λ}_{wp}}$$

where λ_{w} and λ_{wp} are the mobilities to the test brine before and after injection of the dispersion of polymeric microparticles, when measured at the same flow rate.

### Sandpack Experiments Using the Five Foot Sandpack

Three sandpack tests (Tests 1 to 3) were performed using the five foot (152 cm) sandpack. The compositions used in the tests comprised sulfobetainised crosslinked microparticles having a transition temperature of 60° C. (Tests 1 and 3) or a transition temperature of 80° C. (Test 2). The sandpack used in Tests 1 and 2 comprised Sand A having a permeability of approximately 6.5D (Darcy). The sandpack used in Test 3 comprised Sand B having a permeability of 280 mD (milliDarcy).

Initial permeabilities for a 0.3 M NaCl brine across the sandpacks were determined at ambient temperature and were averaged for all test flow rates. These average initial permeabilities are given in Table 4 below.

After the initial permeabilities to the 0.3 M NaCl brine had been obtained, the trace heating for the sandpacks was switched on, thereby achieving the temperatures given in FIG. 7a (Tests 1 and 3) and FIG. 7b (Test 2). Baseline differential pressures using the 0.3M NaCl brine, at a test flow rate of 0.1 ml/min and at the test temperature, were then obtained. The sandpacks were then cooled to ambient temperature and a test composition comprising sulfobetainized crosslinked microparticles dispersed in the sodium chloride brine was then injected.

In Test 1, the sandpack was initially injected with a composition having a concentration of microparticles of 1000 ppm before injecting a composition having a test concentration of microparticles of 5000 ppm (the microparticles having a transition temperature of 60° C.). In Test 2, the sandpack was injected with a composition having a test concentration of microparticles of 5000 ppm (the microparticles having a transition temperature of 80° C.). In Test 3, three different microparticle test compositions were injected having initial, intermediate and final (test) concentrations of microparticles of 1000 ppm, 2500 ppm and 5000 ppm respectively (the microparticles having transition temperatures of 60° C.).

In each of Tests 1 to 3, the microparticles were found to both successfully inject into and propagate through the sandpacks. In Test 3, with the low permeability 250 mD sandpack, consecutive rises in differential pressures across successive pack sections provided evidence that the microparticles propagated through each section of the pack. A rise in differential pressure was not seen in the more permeable 6.5D packs (Tests 1 and 2). FIG. 8 shows the differential pressures for Tests 1 and 3 (for the high and low permeability sandpacks) during injection of microparticle compositions having concentrations of microparticles of 1000 ppm (the microparticles having a transition temperature of 60° C.).

Once the sandpacks were saturated with the microparticle composition, i.e., the concentration of microparticles in the effluent removed from the column was equivalent to the concentration of microparticles in the stock microparticle composition (the composition prior to injection into the column), the trace heating for the sandpacks was turned on, to achieve the temperatures given in FIG. 7a or 7b. Microparticle compositions continued to be injected at a flow rate of 0.1 ml/min as the sandpacks were heated to the test temperatures. Injection of the microparticles at the test temperatures was continued until a resistance factor (RF) equal to or in excess of 20 was obtained. The trace heating was then turned off and, during cooling of the sandpack, injection of the microparticle composition was continued at a flow rate of 0.1 ml/min.

FIGS. 9a and 9b show the differential pressures during heating (block formation) and cooling (at about 43 hours) for Tests 1, 2 and 3. Block formation occurred in all cases in the sandpack section where the microparticles first reached the trigger temperature. This occurred in the second section of the sand packs (dP2 in FIGS. 7a and 7b). For Test 1 (having a sandpack permeability of 6.5D, and a microparticle transition temperature of 60° C.), an RF of 30 was achieved with a dp of about 10 psi. For Test 2 (having a sandpack permeability of 6.5D, and a microparticle transition temperature of 80° C.), an RF of 25 was achieved with a dp of about 5.5 psi. For Test 3 (having a sandpack permeability of 0.28D, and microparticle transition temperature of 60° C.), an RF of 20 was achieved with a dp of about 150 psi. It can be seen that for all three sandpacks, the blocks of microparticles dispersed upon cooling and the differential pressures returned to those similar to pre-blocking measurements. Further evidence for dispersion of the blocks is shown in FIG. 10 where the block becomes progressively smaller in size as it moves through subsequent sandpack sections (as evidenced by lower differential pressures with distance and with cooling).

Final permeabilities for a 0.3 M NaCl brine across the sandpacks for Tests 1 to 3 were determined at ambient temperature and were averaged for all test flow rates. These final permeabilities are also given in Table 4 below.

A measure of the reversibility of the microparticle block formation is given by the Residual Resistance Factor (RRF), with an RRF of 1 showing complete reversibility (and also no particle retention or adsorption). An RRF of up to 1.2 is an indication of good block reversibility. Table 5 below gives RRF values for Tests 1 to 3. It can be seen that for tests employing the 6.5D sandpacks (Tests 1 and 2) the RRF value was about 1.1 indicative of good block reversal. For Test 3 using the less permeable sandpack having a permeability of 0.28D, the RRF was higher at about 1.4. This may be due to microparticle retention in the low permeability sandpack rather than poor block reversal (poor dispersion of the microparticles). Table 5 also shows that the RRF in the section of the sandpack where the block was formed was higher than in other sections.

TABLE 4
Initial and final brine (0.3M NaCl) permeabilities for 5 foot sandpacks

| Sandpack | Microparticle | Initial or Final | Permeability (D) | | | | | |
|---|---|---|---|---|---|---|---|---|
| Test | UCST (° C.) | Permeability | 320dP | dP1 | dP2 | dP3 | dP4 | dP5 |
| 1 | 60 | Initial | 6.62 | 6.63 | 5.84 | 6.22 | 7.39 | 8.00 |
| | | Final | 4.62 | 2.50 | 5.43 | 5.76 | 6.97 | 7.33 |
| 2 | 80 | Initial | 6.19 | 6.56 | 5.83 | 6.31 | 6.12 | 7.02 |
| | | Final | 5.73 | 5.78 | 5.58 | 5.73 | 5.53 | 6.28 |
| | | | Permeability (D) | | | | | |
| | | | | Inlet- | | | | PT4- |
| | | | PTdP | PT1 | PT1-PT2 | PT2-PT3 | PT3-PT4 | outlet |
| 3 | 60 | Initial | 0.281 | 0.258 | 0.273 | 0.283 | 0.285 | 0.312 |
| | | Final | 0.178 | 0.104 | 0.213 | 0.239 | 0.244 | 0.215 |

dP = differential pressure measured from a differential pressure transducer reading across the pack section.
PTdP = differential pressure calculated as the difference of two single point pressure readings either side of a pack section.

TABLE 5
RRF (at flow rate of 0.1 ml/min) for 5 foot sandpacks, at ambient temperature

| Sandpack | Microparticle | RRF | | | | | |
|---|---|---|---|---|---|---|---|
| Test | UCST (° C.) | 320dP | dP1 | dP2 | dP3 | dP4 | dP5 |
| 1 | 60 | 1.38 | 2.86 | 1.03 | 1.04 | 1.02 | 1.05 |
| 2 | 80 | 1.11 | 1.16 | 1.06 | 1.12 | 1.13 | 1.14 |
| | | RRF | | | | | |
| | | | Inlet- | | | | PT4- |
| | | PTdP | PT1 | PT1-PT2 | PT2-PT3 | PT3-PT4 | outlet |
| 3 | 60 | 1.42 | 2.41 | 1.26 | 1.12 | 1.10 | 1.11 |

dP = differential pressure measured from a differential pressure transducer reading across a pack section
PTdP = differential pressure calculated as the difference of two single point pressure readings either side of a pack section

1. A process for reducing the permeability to water of a thief zone of a porous and permeable subterranean petroleum reservoir, said process comprising:
injecting a composition comprising a dispersion of betainised crosslinked polymeric microparticles in an aqueous fluid down a well and into a thief zone,
wherein the betainised crosslinked polymeric microparticles have a transition temperature which is at or below the maximum temperature encountered in the thief zone and greater than the maximum temperature encountered in the well, and
wherein the betainised crosslinked polymeric microparticles are solvated by water and expand in size in the thief zone when they encounter a temperature at or greater than the transition temperature so as to reduce the permeability of the thief zone to water.

2. A process for recovering hydrocarbon fluids from a porous and permeable subterranean petroleum reservoir comprising at least one higher permeability layer of reservoir rock and at least one lower permeability layer of reservoir rock that are penetrated by at least one injection well and at least one production well, the process comprising:
i) injecting into the higher permeability layer of reservoir rock a composition comprising betainised crosslinked polymeric microparticles dispersed in an aqueous fluid wherein the higher permeability layer has a region between the injection well and production well having a temperature at or above the transition temperature of the betainised crosslinked microparticles;
ii) propagating said composition through the higher permeability layer until the composition reaches the region of the higher permeability layer having a temperature at or above the transition temperature such that betainised crosslinked microparticles become solvated and expand in size thereby reducing the permeability of the higher permeability layer of the reservoir and diverting subsequently injected aqueous fluid into the lower permeability layer of the reservoir; and
iii) recovering hydrocarbon fluids from said at least one production well.

3. The process of claim 2, wherein the higher permeability layer(s) of reservoir rock has a permeability at least 50% greater than the permeability of the lower permeability layer(s) of reservoir rock.

4. The process of claim 2, wherein the composition comprising betainised microparticles is injected into the injection well at a temperature in the range of 4 to 30° C. and the transition temperature of the betainised microparticles is in the range of 20° C. to 120° C. with the proviso that the transition temperature is greater than the injection temperature.

5. The process of claim 2, wherein the composition comprising betainised microparticles is injected in a pore volume amount in the range of 0.05 to 1, preferably 0.2 to 0.5.

6. The process of claim 2, wherein the initial average particle diameter of the betainised microparticles is in the range of 0.1 to 1 μm and the average particle diameter of the expanded betainised microparticles is in the range of 1 to 10 microns.

7. A method for preparing betainised microparticles, said method comprising:
reacting precursor polymeric microparticles comprising crosslinked polymer chains having pendant groups comprising a betainisable functional group with a betainising reagent to convert at least a portion of the betainisable functional groups to betainised functional groups thereby forming betainised microparticles comprising crosslinked polymer chains having pendant groups comprising a betainised functional group and optionally having pendant groups comprising an unreacted betainisable functional group.

8. The method of claim 7, wherein the precursor polymeric microparticles are reacted with a betainising reagent selected from sulfobetainising, carboxybetainising, phosphobetainising, phosphonobetainising and sulfabetainising reagents to form betainised microparticles in which at least a portion of the betainisable functional groups are converted to betainised functional groups.

9. The method of claim 7, wherein the precursor microparticles are prepared by emulsion polymerization or dispersion polymerization of a mixture of monomers comprising:
(a) monomers having betainisable functional groups;
(b) crosslinking monomers; and
(c) optionally, hydrophobic comonomers that do not contain a betainisable functional group.

10. The method of claim 9, wherein the monomers having betainisable functional groups are selected from the group consisting of dialkylaminoalkyl acrylates; dialkylaminoalkyl alkacrylates; dialkylaminoalkyl acrylamides; dialkylaminoalkyl alkacrylamides; vinylaryldialkylamines; and vinyl-N-heterocyclic amines.

11. The method of claim 10, wherein the monomers having betainisable functional groups are vinyl-N-heterocyclic amines and the resulting precursor microparticles have structural units with pendant N-heterocyclic amine rings that are reacted with the betainising reagent to form betainised N-heterocyclic ammonium rings.

12. The method of claim 10, wherein the monomers having betainisable functional groups are dialkylaminoalkyl acrylates and alkacrylates of general formula (I):
[H₂C═C(R¹)CO₂R²NR³R⁴]
wherein R¹ is selected from hydrogen and methyl;
R² is a straight chain alkylene moiety having from 2 to 10 carbon atoms or a branched chain alkylene moiety having a main chain having from 2 to 10 carbons atoms and at least one branched chain having from 2 to 10 carbon atoms with the proviso that the straight or branched chain alkylene moiety is optionally substituted by methyl; and
R³ and R⁴ are independently selected from methyl, ethyl, n-propyl and isopropyl, or N, R³ and R⁴ together form an N-heterocyclic amine ring, optionally, including an oxygen heteroatom.

13. The method of claim 10, wherein the monomers having betainisable functional groups are dialkylaminoalkyl acrylamides and alkacrylamides of the formula (II):
[H₂C═C(R¹)CONHR²NR³R⁴]
wherein R¹R²R³ and R⁴ are as defined in claim 12.

14. The method of claim 10, wherein the monomers having betainisable functional groups are vinylbenzyldialkylamines of the general formula (III):
[H₂C═C(R¹)C₆H₄R²NR³R⁴]
wherein R¹, R², R³ and R⁴ are as defined in claim 12 or are vinylbenzyldialkylamines analogues of those of general formula (III) in which the benzyl group has from one to three substituents selected from methyl, ethyl, halogen, alkoxy and nitro groups.

15. The method of claim 12, wherein the crosslinking monomer comprises from 0.1 to 10 mol %, preferably 0.5 to 3 mol % of the mixture of monomers used to prepare the precursor microparticles.

16. The method of claim 9, wherein the crosslinking monomers are selected from diacrylamides and methacrylamides of diamines such as the diacrylamide or dimethacrylamide of piperazine or diacrylamide or dimethacrylamide of methylenediamine; methacrylate esters of di, tri, tetra hydroxy compounds including ethyleneglycol dimethacrylate, polyethyleneglycol dimethacrylate, trimethylolpropane trimethacrylate, and the like; divinylbenzene, 1,3-diisopropenylbenzene, and the like; the vinyl or allyl esters of di or trifunctional acids; and, diallylamine, triallylamine, divinyl sulfone, diethyleneglycol diallyl ether, and the like.

17. The method of claim 9, wherein the hydrophobic comonomers are selected from benzyl methacrylate, benzyl acrylate, benzyl acrylamide, benzyl methacrylamide, n-butyl methacrylate, n-butyl acrylate, n-butyl acrylamide, n-butyl methacrylamide, and the like; and styrenic monomers substituted with branched alkyl, straight chain alkyl or aryl groups and comprise up to 50 mol % of the mixture of monomers used to prepare the precursor microparticles.

18. The method of claim 7, wherein the betainisation reagent is of general formula V:
XRA⁻M⁺
wherein X is a halogen selected from F, Cl, Br and I, preferably, CI and Br;
R is a hydrocarbylene group having up to 30 carbon atoms wherein the hydrocarbylene group may be selected from: branched or unbranched alkylene groups; arylene groups; alkarylene groups (an alkyl substituted arylene group wherein the alkyl substituent may be branched or unbranched); and arylalkylene groups (an aryl substituted alkylene group where the alkylene group may be branched or unbranched); and wherein the alkylene, arylene, alkarylene or arylalkylene groups may be optionally substituted with functional groups selected from hydroxyl, ether, ester, amide, and the like;
A⁻ is an anionic functional group selected from SO₃⁻ (sulfonate), PO₃⁻ (phosphonate), OPO₃⁻ (phosphate), CO₃⁻ (carboxylate) and OSO₃⁻ (ether sulfonate; also referred to as sulfate) functional groups, preferably, SO₃⁻ (sulfonate); and
M⁺ is selected from H⁺, Group IA metal cations and ammonium cations.

19. The method of claim 18, wherein the betainisation reagent is a betainisation reagent having a halide leaving group of general formula Va:
XCH₂(CH₂)ₙCH₂A⁻M⁺
wherein X, A⁻ and M⁺ are as defined above; and
n is an integer in the range of 0 to 20, preferably 0 to 10, in particular, 0 to 3.

20. The method of claim 7, wherein the betainising reagent is a cyclic betainising reagent selected from the group consisting of sultones; lactones; dioxaphospholane oxides; dioxathiolane dioxides; and dioxathiane dioxides.

21. Betainised microparticles comprising:
crosslinked polymer chains in the form of microparticles,
wherein the crosslinked polymer chains have: pendant groups comprising betainised functional groups, and pendant groups comprising unreacted betainisable functional groups,
wherein the betainised functional groups are present in the microparticles in an amount of from 50% to 95% based on the total amount of betainised and unreacted betainisable functional groups.

22. Betainised microparticles of claim 21, wherein the microparticles are selected from sulfobetainised microparticles, carboxybetainised microparticles phosphobetainised microparticles, phosphonobetainised microparticles and sulfabetainised microparticles, preferably selected from sulfobetainised microparticles and sulfabetainised microparticles.

23. Betainised microparticles of claim 22, wherein the betainised microparticles comprise betainised groups selected from: (2-sulfoethyl)-ammonium betaine groups, (3-sulfopropyl)-ammonium betaine groups, (4-sulfobutyl)-ammonium betaine groups, (2-carboxyethyl)-ammonium betaine groups, (3-carboxypropyl)-ammonium betaine groups, (4-carboxybutyl)-ammonium betaine groups, (2-phosphoethyl)-ammonium betaine groups, (3-phosphopropyl)-ammonium betaine groups, (4-phosphobutyl)-ammonium betaine groups, (2-phosphonoethyl)-ammonium betaine groups, (3-phosphonopropyl)-ammonium betaine groups, (4-phosphonobutyl)-ammonium betaine groups, (2-sulfaethyl)-ammonium betaine groups, (3-sulfapropyl)-ammonium betaine groups, and (4-sulfabutyl)-ammonium betaine groups.

24. A composition comprising:
an aqueous fluid; and
a dispersion of betainised microparticles in the aqueous fluid,
where the betainised microparticles comprise:
crosslinked polymer chains in the form of microparticles,
wherein the crosslinked polymer chains have: pendant groups comprising betainised functional groups, and pendant groups comprising unreacted betainisable functional groups,
wherein the betainised functional groups are present in the microparticles in an amount of from 50% to 95% based on the total amount of betainised and unreacted betainisable functional groups.

25. The composition of claim 24, wherein the composition comprises from 0.01 to 20% by weight, preferably from 0.01 to 10% by weight, more preferably from 0.02 to 5% by weight, and most preferably from 0.05 to 3% by weight of the betainised microparticles based on the total weight of the composition.

26. The composition of claim 24, wherein the aqueous fluid has a total dissolved solids (TDS) content in the range of 200 to 250,000 mg/L, preferably, in the range of 500 to 50,000 mg/L, more preferably, 1500 to 35,000 mg/L.

27. The composition of claim 29, wherein the aqueous fluid is selected from seawater, estuarine water, brackish water, lake water, river water, desalinated water, produced water, aquifer water or mixtures thereof, preferably seawater.

28. The process of claim 1, wherein the composition comprising betainised microparticles is injected into the injection well at a temperature in the range of 4° C. to 30° C. and the transition temperature of the betainised microparticles is in the range of 20° C. to 120° C. with the proviso that the transition temperature is greater than the injection temperature.

29. The process of claim 1, wherein the composition comprising betainised microparticles is injected in a pore volume amount in the range of 0.05 to 1, preferably 0.2 to 0.5.

30. The process of claim 1, wherein the initial average particle diameter of the betainised microparticles is in the range of 0.1 to 1 μm and the average particle diameter of the expanded betainised microparticles is in the range of 1 to 10 microns.
